(19) United States
(12) Patent Application Publication
(10) Pub. No.: US 2026/0056485 A1
(43) Pub. Date: Feb. 26, 2026

(54) TONER AND IMAGE FORMING METHOD

(71) Applicant: ZEON CORPORATION, Tokyo (JP)

(72) Inventors: Takeshi Hirata, Tokyo (JP); Sakyo Yagyu, Tokyo (JP)

(73) Assignee: ZEON CORPORATION, Tokyo (JP)

(21) Appl. No.: 19/103,377

(22) PCT Filed: Aug. 28, 2023
(86) PCT No.: PCT/JP2023/030847

§ 371 Date: Feb. 12, 2025

(30) Foreign Application Priority Data
Aug. 31, 2022 (JP) 2022-137490

(51) Int. Cl. G03G 9/097; G03G 9/09

(52) U.S. Cl. CPC G03G 9/09741; G03G 9/0926

(57) ABSTRACT

A toner comprising colored resin particles, which contain a binder resin, a colorant, a positively-chargeable charge control resin and a release agent, and an external additive, wherein the positively-chargeable charge control resin comprises a copolymer A, which contains a functional group-containing monomer unit in an amount of 1.50% by mass or more and 6.00% by mass or less, and a copolymer B, which contains a functional group-containing monomer unit in an amount of 0.10% by mass or more and less than 1.50% by mass, and wherein the colored resin particles further contain a polar resin having an acid value of 0.5 mgKOH/g or more and 8.0 mgKOH/g or less.

### TECHNICAL FIELD

The present disclosure relates to a toner which is used to develop an electrostatic latent image in electrophotography, electrostatic recording, electrostatic printing and the like, and an image forming method using the toner.

### BACKGROUND ART

In an image forming device such as an electronic photographic device, an electrostatic recording device and an electrostatic printing device, first, an electrostatic latent image formed on the photoconductor is developed using a toner; the toner image is transferred onto a transferring material such as a sheet of paper; and the material is heated to fix the image, thereby obtaining a fixed image.

In a toner fixing step, generally, at the time of fixing, the temperature of a fixing roller needs to be increased to 150° C. or more and large amounts of electricity is necessary. With an increasing demand for an image forming device low in energy consumption and high in printing speed, there is a demand for a toner that can retain a high fixing rate even at low fixing temperature, that is, a toner having excellent low temperature fixability.

Meanwhile, a toner having improved low temperature fixability may be likely to cause blocking at high temperature or during a long-term storage, that is, the storage stability of the toner may decrease. Accordingly, there is a demand for the development of a toner having improved low temperature fixability without a deterioration in storage stability.

As a toner that is well-balance between storage stability and low temperature fixability, for example, Patent Document 1 discloses a toner comprising colored resin particles, which contain a binder resin, a colorant and a release agent, and an external additive, wherein the colored resin particles further comprise a styrene-based thermoplastic elastomer, and wherein the release agent comprises a fatty acid ester compound, which has a number average molecular weight (Mn) of 500 or more and less than 2,000, at a content of from 2 parts by mass to 20 parts by mass with respect to 100 parts by mass of the binder resin.

Patent Document 2 discloses a toner comprising color resin particles, which contain a binder resin, a colorant, a charge control agent and a release agent, wherein the color resin particles further comprise an additive having a polydiene structure and having a solubility in 40° C. styrene of from 3 g/100 g to 40 g/100 g, and wherein, in the colored resin particles, the number of crystal domains of the release agent, which has an aspect ratio in a range of from 2 to 10, is in a specific range, or the storage modulus G′(60) of the colored resin particles at 60° C., which is obtained by dynamic viscoelasticity measurement, is in a specific range.

Patent Document 3 discloses a toner comprising colored resin particles, which contain a binder resin, a colorant, a softening agent, and an external additive, wherein the toner further comprises a retention aid that is a copolymer of at least one of acrylic acid ester or methacrylic acid ester and at least one of acrylic acid or methacrylic acid, and wherein the copolymer has an acid value of from 0.5 mgKOH/g to 7 mgKOH/g, a weight average molecular weight Mw of from 6,000 to 50,000, and a glass transition temperature of from 60° C. to 85° C.

### CITATION LIST

### Patent Documents

Patent Document 1: International Publication No. WO2019/065868
Patent Document 2: International Publication No. WO2020/045664
Patent Document 3: International Publication No. WO2014/133032

### SUMMARY

### Technical Problem

The toners disclosed in Patent Documents 1 to 3 contain a release agent. Since the release agent improves the releasability of the toner from a fixing roller, it is effective in improving the low temperature fixability of the toner.

Meanwhile, the release agent is likely to bleed out, and the bleeding may contaminate a printing member such as a photoconductor and cause a print failure such as fogging. Accordingly, there is a demand for a toner in which the release agent is less likely to bleed out. However, as the temperature and humidity of the toner storage environment increase, the speed of transfer of the release agent in the binder resin to the toner surface increases, and the release agent is likely to bleed out, accordingly. The toners disclosed in Patent Documents 1 to 3 are difficult to sufficiently suppress that the release agent bleeds out in a high-temperature and high-humidity environment at more than 45° C. When a conventional toner is stored in such a high-temperature and high-humidity environment, there is a problem such that printing with the toner after storage is likely to cause a print failure such as fogging.

Also in recent years, for the purpose of reducing component cost, toner cartridges filled with large amounts of toners are often used. When a large amount of toner is filled into a cartridge, during continuous printing, the toner is subjected to mechanical stress for a longer time. Accordingly, in the case of continuous printing with the use of a toner cartridge filled with a large amount of toner, there is a problem such that a print failure is caused by a decrease in the charge amount of the toner in the toner cartridge, increasing the amount of the remaining toner which is left unusable.

An object of the present disclosure is to provide a toner having the following properties: the release agent is less likely to bleed out even in a high-temperature and high-humidity environment; a print failure is less likely to occur even when the toner is used after long-time storage in a high-temperature and high-humidity environment; when a toner cartridge filled with a large amount of the toner is used, in both a low-temperature and low-humidity environment and a high-temperature and high-humidity environment, continuous printing can be carried out while suppressing a print failure, until the amount of the remaining toner is low; and a fluctuation in the charge amount of the toner, which is involved in temperature and humidity changes, is suppressed. Another object of the present disclosure is to provide an image forming method using the toner.

### Solution to Problem

As a result of intensive studies with the aim of achieving the above objects, the present inventors found the following: by using two kinds of positively-chargeable charge control resins having different functional group amounts in combination with a polar resin having a specific acid value, the occurrence of bleeding of a release agent is suppressed in a toner, even in a high-temperature and high-humidity environment; a print failure can be suppressed even after the toner is stored for a long time in a high-temperature and high-humidity environment, or even in a low-temperature and low-humidity environment and a high-temperature and high-humidity environment; and a fluctuation in the charge amount of the toner, which is involved in temperature and humidity changes, can be suppressed.

According to the present disclosure, there is provided a toner comprising colored resin particles, which contain a binder resin, a colorant, a positively-chargeable charge control resin and a release agent, and an external additive,
wherein the positively-chargeable charge control resin comprises a copolymer A, which contains a functional group-containing monomer unit in an amount of 1.50% by mass or more and 6.00% by mass or less, and a copolymer B, which contains a functional group-containing monomer unit in an amount of 0.10% by mass or more and less than 1.50% by mass, and
wherein the colored resin particles further contain a polar resin having an acid value of 0.5 mgKOH/g or more and 8.0 mgKOH/g or less.

According to the present disclosure, there is also provided a toner comprising colored resin particles, which contain a binder resin, a colorant, a positively-chargeable charge control resin and a release agent, and an external additive,
wherein the positively-chargeable charge control resin comprises a copolymer A, which contains a functional group-containing monomer unit in an amount of 1.50% by mass or more and 6.00% by mass or less, and a copolymer B, which contains a functional group-containing monomer unit in an amount of 0.10% by mass or more and less than 1.50% by mass, and
wherein the colored resin particles further contain a polar resin having an acid value of 0.5 mgKOH/g or more and 5.0 mgKOH/g or less.

In the toner of the present disclosure, a sum of products of F and m (F×m) calculated for each of the copolymers contained as the positively-chargeable charge control resin, is preferably 2.00 or more and 6.00 or less when, in each of the copolymers, an amount (% by mass) of the functional group-containing monomer unit is represented as F, and a content (parts by mass) of the copolymer with respect to 100 parts by mass of the binder resin is represented as m.

In the toner of the present disclosure, an absolute value (|X×m_{P}−F_{A}×m_{A}|) of a difference between a product of X and mₚ (X×m_{P}) and a product of F_{A} and m_{A} (F_{A}×m_{A}) is preferably 2.50 or less, when the acid value (mgKOH/g) of the polar resin is represented as X; a content (parts by mass) of the polar resin with respect to 100 parts by mass of the binder resin is represented as m_{P}; the amount (% by mass) of the functional group-containing monomer unit in the copolymer A is represented as F_{A}; and a content (parts by mass) of the copolymer A with respect to 100 parts by mass of the binder resin is represented as m_{A}.

In the toner of the present disclosure, the release agent preferably comprises a fatty acid ester compound, which has a number average molecular weight (Mn) of 500 or more and less than 2,000, at a content of 5 parts by mass or more and 30 parts by mass or less with respect to 100 parts by mass of the binder resin.

In the toner of the present disclosure, the colored resin particles preferably further comprise a styrene-based thermoplastic elastomer at a content of 1 part by mass or more and 10 parts by mass or less with respect to 100 parts by mass of the binder resin.

According to the present disclosure, there is provided an image forming method using the toner of the present disclosure.

### Advantageous Effects of Invention

According to the present disclosure as described above, a toner having the following properties is provided: the release agent is less likely to bleed out even in a high-temperature and high-humidity environment; a print failure is less likely to occur even when the toner is used after long-time storage in a high-temperature and high-humidity environment; when a toner cartridge filled with a large amount of the toner is used, in both a low-temperature and low-humidity environment and a high-temperature and high-humidity environment, continuous printing can be carried out while suppressing a print failure, until the amount of the remaining toner is low; and a fluctuation in the charge amount of the toner, which is involved in temperature and humidity changes, is suppressed. Also, by using the toner, an image forming method which is less likely to cause a print failure is provided.

### DESCRIPTION OF EMBODIMENTS

The toner of the present disclosure is a toner comprising colored resin particles, which contain a binder resin, a colorant, a positively-chargeable charge control resin and a release agent, and an external additive,
wherein the positively-chargeable charge control resin comprises a copolymer A, which contains a functional group-containing monomer unit in an amount of 1.50% by mass or more and 6.00% by mass or less, and a copolymer B, which contains a functional group-containing monomer unit in an amount of 0.10% by mass or more and less than 1.50% by mass, and
wherein the colored resin particles further contain a polar resin having an acid value of 0.5 mgKOH/g or more and 8.0 mgKOH/g or less, and preferably an acid value of 0.5 mgKOH/g or more and 5.0 mgKOH/g or less.

The toner of the present disclosure contains, as the positively-chargeable charge control resin in the colored resin particles, a combination of the copolymer A, in which the amount of the functional group-containing monomer unit (in the present disclosure, it may be simply referred to as “functional group amount”) is relatively large, and the copolymer B, which has a relatively small functional group amount. In addition, the toner contains, in the colored resin particles, the polar resin having an acid value that is within the above-described range. Accordingly, the toner of the present disclosure is a toner having the following properties: the release agent is less likely to bleed out even in a high-temperature and high-humidity environment at more than 45° C.; a print failure is less likely to occur even when the toner is used after long-time storage in such a high-temperature and high-humidity environment; when a toner cartridge filled with a large amount of the toner is used, in both a low-temperature and low-humidity environment and a high-temperature and high-humidity environment, continuous printing can be carried out while suppressing a print failure, until the amount of the remaining toner is low; and a fluctuation in the charge amount, which is involved in temperature and humidity changes, is suppressed.

The charge imparting effect of a copolymer containing a functional group, which is used as a positively-chargeable charge control resin, increases as the functional group amount increases. Meanwhile, a polar resin having an acid value functions to decrease the charge amount of a toner. This is because the acidic group contained in the polar resin causes charge leakage due to moisture absorption.

When the charge amount of the toner is too large, the amount of the transferred toner is insufficient, resulting in an insufficient image density. On the other hand, when the charge amount of the toner is too small, the electrostatic repulsion of the toner particles against a photoconductor decreases, and the toner particles are likely to attach to the photoconductor. The toner particles attached to the photoconductor cause fogging. The charge amount of the toner tends to increase in a low-temperature and low-humidity environment and decrease in a high-temperature and high-humidity environment.

Also in the toner containing the polar resin, since the acidic group of the polar resin is likely to adsorb moisture in a high-temperature and high-humidity environment, charge leakage is likely to be caused by the polar resin. Accordingly, the charge amount is likely to decrease.

Meanwhile, the toner of the present disclosure has an appropriate charge amount since the toner contains the copolymers A and B, each of which has a functional group amount that is in the range specified above in combination with the polar resin having an acid value that is in the range specified above. Accordingly, a print failure such as fogging and insufficient image density is less likely to occur in both a low-temperature and low-humidity environment and a high-temperature and high-humidity environment. In addition, the toner of the present disclosure can easily retain an appropriate charge amount, even when there is an environmental change or during continuous printing. During continuous printing with the use of a toner cartridge filled with a large amount of toner, the toner is subjected to mechanical stress for a longer time. However, since the toner of the present disclosure can easily retain an appropriate charge amount, when a toner cartridge filled with a large amount of the toner is used, in both a low-temperature and low-humidity environment and a high-temperature and high-humidity environment, continuous printing can be carried out while suppressing a print failure, until the amount of the remaining toner is low.

In addition, since the acid value of the polar resin contained in the toner of the present disclosure is not too high, a decrease in the charge amount of the toner of the present disclosure is suppressed even in a high-temperature and high-humidity environment, and a fluctuation in the charge amount, which is involved in temperature and humidity changes, is less likely to occur.

The copolymer containing the functional group and the polar resin having the acid value tend to be unevenly distributed on the surface side of the colored resin particles, when the functional group amount is large or the acid value is high.

It is presumed that since the toner of the present disclosure contains the copolymers A and B, each of which has a functional group amount that is in the range specified above in combination with the polar resin having an acid value that is in the range specified above, they are unevenly distributed on the surface side of the colored resin particles; and a dense resin layer is formed on the surface of the colored resin particles; and the occurrence of bleeding of the release agent is suppressed even in a high-temperature and high-humidity environment at more than 45° C., accordingly.

When printing is carried out by use of a toner in which the release agent bleeds out of the toner particles, fogging is likely to occur. Once the release agent bleeds out, in a printing process, the release agent transfers from the toner to a regulation blade or the like, and the release agent attached to the regulation blade or the like causes fogging. A cause for fogging that occurs when a conventional toner is used for printing after long-time storage in a high-temperature and high-humidity environment, may be an insufficient charge amount of the toner; however, it is due largely to the influence of the release agent that bleeds out during storage.

Meanwhile, even when the toner of the present disclosure is stored for a long time in a high-temperature and high-humidity environment, the release agent is less likely to bleed out, and the toner has an appropriate charge amount. Accordingly, a print failure such as fogging is less likely to be caused by the toner of the present disclosure, even when the toner is used after long-time storage in a high-temperature and high-humidity environment and the used.

Hereinafter, the method for producing the colored resin particles contained in the toner of the present disclosure, the colored resin particles obtained by the production method, and the toner of the present disclosure will be described in this order.

In the present disclosure, “to” in a numerical range is used to describe a range in which the numerical values described before and after “to” indicate the lower limit value and the upper limit value.

### 1. Method for Producing Colored Resin Particles

In general, methods for producing colored resin particles are broadly classified into dry methods such as a pulverization method and wet methods such as an emulsion polymerization agglomeration method, a suspension polymerization method and a dissolution suspension method. The wet methods are preferred since a toner with excellent printing characteristics such as image reproducibility, can be easily obtained. Among the wet methods polymerization methods such as an emulsion polymerization agglomeration method and a suspension polymerization method are preferred, since a toner having a relatively small particle size distribution in micron order can be easily obtained. Among the polymerization methods, a suspension polymerization method is more preferred.

In the emulsion polymerization aggregation method, a polymerizable monomer emulsified is polymerized to obtain a resin fine particle emulsion, and is aggregated with a colorant dispersion or the like, thereby obtaining colored resin particles. In the dissolution suspension method, a solution in which toner components such as a binder resin and a colorant are dissolved or dispersed in an organic solvent is formed into liquid droplets in an aqueous medium, and the organic solvent is removed, thereby obtaining colored resin particles. As those methods, known methods can be used.

The colored resin particles contained in the toner of the present disclosure can be produced by using a wet method or a dry method. In the case of producing the colored resin particles by using (A) a suspension polymerization method, which is a preferred wet method, or by using (B) a pulverization method, which is a typical dry method, the colored resin particles can be produced by the following processes.

### (A) Suspension Polymerization Method

### (A-1) Preparation Step of Polymerizable Monomer Composition

First, a polymerizable monomer, a colorant, a positively-chargeable charge control resin, a polar resin, a release agent, and other additives which are added as needed, such as a styrene-based thermoplastic elastomer and a molecular weight modifier, are mixed to prepare a polymerizable monomer composition. An in-line type emulsifying disperser or a media type emulsifying disperser is used for the mixing in the preparation of the polymerizable monomer composition.

### (Polymerizable Monomer)

In the present disclosure, the polymerizable monomer is a monomer containing a polymerizable functional group. Polymerizable monomers are polymerized to become a binder resin. As the main component of the polymerizable monomer, a monovinyl monomer is preferably used. Examples of the monovinyl monomer include, but are not limited to, styrene; styrene derivatives such as vinyltoluene and α-methylstyrene; acrylic acid and methacrylic acid; acrylic esters such as methyl acrylate, ethyl acrylate, propyl acrylate, butyl acrylate, 2-ethylhexyl acrylate and dimethylaminoethyl acrylate; methacrylic esters such as methyl methacrylate, ethyl methacrylate, propyl methacrylate, butyl methacrylate, 2-ethylhexyl methacrylate and dimethylaminoethyl methacrylate; nitrile compounds such as acrylonitrile and methacrylonitrile; amide compounds such as acrylamide and methacrylamide; and olefins such as ethylene, propylene and butylene. The monovinyl monomers may be used alone or in combination of two or more thereof. Of them, styrene, styrene derivatives, acrylic esters and methacrylic esters are preferred as the monovinyl monomer. As the main component of the polymerizable monomer, it is particularly preferable to use at least one selected from the group consisting of styrene and styrene derivatives in combination with at least one selected from the group consisting of acrylic esters and methacrylic esters. By using such a polymerizable monomer, the colored resin particles containing a styrene-acrylic resin as the binder resin, are obtained. The main component means a component such that its content rate is more than 50% by mass.

The styrene-acrylic resin is a negatively-chargeable resin. A toner containing a negatively-chargeable binder resin is more susceptible to mechanical stress during continuous printing; moreover, a decrease in the charge amount is likely to be caused by abrasion of the surface of the colored resin particles, when it is made into a positively-chargeable toner, compared to the case when it is made into a negatively-chargeable toner. Meanwhile, in the toner of the present disclosure that is a positively-chargeable toner, a decrease in the charge amount is less likely to be caused by abrasion of the surface of the colored resin particles, even when the toner contains a negatively-chargeable binder resin. This is presumed to be because the colored resin particles have excellent abrasion resistance since the toner of the present disclosure contains the copolymers A and B, which are positively-chargeable charge control resins having different functional group amounts, and since the toner has such a copolymer distribution, that the copolymer A is unevenly distributed on the more surface side of the colored resin particles and the copolymer B is unevenly distributed on the relatively center side of the colored resin particles.

To improve hot offset resistance and storage stability, an optional crosslinkable polymerizable monomer is preferably used in combination with the monovinyl monomer. The crosslinkable polymerizable monomer is a monomer containing two or more polymerizable functional groups. Examples of the crosslinkable polymerizable monomer include, but are not limited to, aromatic divinyl compounds such as divinyl benzene, divinyl naphthalene and derivatives thereof; ester compounds such as ethylene glycol dimethacrylate and diethylene glycol dimethacrylate, in which two or more carboxylic acids containing a carbon-carbon double bond are esterified to an alcohol containing two or more hydroxyl groups; other divinyl compounds such as N,N-divinylaniline and divinyl ether; and compounds containing three or more vinyl groups. The crosslinkable polymerizable monomers may be used alone or in combination of two or more thereof.

In the present disclosure, with respect to 100 parts by mass of the monovinyl monomer, the crosslinkable polymerizable monomer is generally used in an amount of from 0.1 parts by mass to 5 parts by mass, and preferably from 0.3 parts by mass to 2 parts by mass.

In addition, a macromonomer is preferably used as a part of the polymerizable monomer, since the balance between the storage stability and low-temperature fixability of the toner can be improved.

As the macromonomer, examples include a reactive oligomer or polymer having a number average molecular weight of generally from 1,000 to 30,000, which contains a polymerizable carbon-carbon unsaturated double bond at the end of the molecular chain. As the macromonomer, examples include a styrene macromonomer, a styrene-acrylonitrile macromonomer, a polyacrylic ester macromonomer and a polymethacrylic ester macromonomer. Among them, at least one selected from the group consisting of a polyacrylic ester macromonomer or a polymethacrylic ester macromonomer is preferably used. As the acrylic ester used in the polyacrylic ester macromonomer, examples include the above-mentioned acrylic esters usable as the monovinyl monomer. As the methacrylic ester used in the polymethacrylic ester macromonomer, examples include the above-mentioned methacrylic esters usable as the monovinyl monomer. As the macromonomer, it is preferable to appropriately select and use such a macromonomer, that when the polymerizable monomer includes the macromonomer, the glass transition temperature (Tg) of the obtained binder resin is higher than the case where the polymerizable monomer does not include the macromonomer.

As the macromonomer, a commercially-available product may be used. Examples of the commercially-available product of the macromonomer include macromonomer series AA-6, AS-6, AN-6S, AB-6 and AW-6S manufactured by Toagosei Co., Ltd.

The macromonomers may be used alone or in combination of two or more thereof.

When the polymerizable monomer includes the macromonomer, the content of the macromonomer is not particularly limited. The content of the macromonomer is preferably from 0.03 parts by mass to 5 parts by mass, and more preferably from 0.05 parts by mass to 1 part by mass, with respect to 100 parts by mass of the monovinyl monomer.

The content of the polymerizable monomer is not particularly limited. The content of the polymerizable monomer is preferably from 60 parts by to 95 parts by mass, more preferably from 65 parts by mass to 90 parts by mass, and still more preferably from 70 parts by mass to 85 parts by mass, with respect to 100 parts by mass of the total solid content contained in the polymerizable monomer composition.

In the present disclosure, the term “solid content” means all components other than solvents, and liquid monomers and the like are included in the “solid content”.

### (Colorant)

As the colorant, a colorant conventionally used in toners can be appropriately selected and used. The colorant is not particularly limited. When producing a color toner, a black colorant, a cyan colorant, a yellow colorant or a magenta colorant can be used.

Examples of the black colorant include carbon black, titanium black and magnetic powder such as zinc-iron oxide and nickel-iron oxide.

Examples of the cyan colorant include cyan pigments such as phthalocyanine pigments (e.g., copper phthalocyanine pigments and derivatives thereof) and anthraquinone pigments, and cyan dyes. The specific examples include C.I. Pigment Blue 2, 3, 6, 15, 15:1, 15:2, 15:3, 15:4, 16, 17:1 and 60, and C.I. Solvent Blue 70.

Examples of the yellow colorant include yellow pigments such as azo-based pigments (e.g., monoazo pigments and disazo pigments) and condensed polycyclic pigments, and yellow dyes. The specific examples include C.I. Pigment Yellow 3, 12, 13, 14, 15, 17, 62, 65, 73, 74, 83, 93, 97, 120, 138, 155, 180, 181, 185, 186, 213 and 214, and C.I. Solvent Yellow 98 and 162.

Examples of the magenta colorant include magenta pigments such as azo-based pigments (e.g., monoazo pigments and disazo pigments) and condensed polycyclic pigments (e.g., quinacridone pigments), and magenta dyes. The specific examples include C.I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255 and 269; C.I. Pigment Violet 19; C.I. Solvent Red 1, 3, 8, 23, 24, 25, 27, 30, 49, 81, 82, 83, 84, 100, 109 and 121; C.I. Disperse Red 9; C.I. Solvent Violet 8, 13, 14, 21 and 27; C.I. Disperse Violet 1; C.I. Basic Red 1, 2, 9, 12, 13, 14, 15, 17, 18, 22, 23, 24, 27, 29, 32, 34, 35, 36, 37, 38, 39 and 40; and C.I. Basic Violet 1, 3, 7, 10, 14, 15, 21, 25, 26, 27 and 28.

The colorants may be used alone or in combination of two or more thereof.

The content of the colorant is not particularly limited. From the viewpoint of obtaining sufficient image density, the content of the colorant is preferably from 5 parts by mass to 15 parts by mass, and more preferably from 7 parts by mass to 13 parts by mass, with respect to 100 parts by mass of the binder resin. Also, the content of the colorant in the toner is preferably from 5 parts by mass to 15 parts by mass, and more preferably from 7 parts by mass to 13 parts by mass, with respect to 100 parts by mass of the binder resin.

In the present disclosure, 100 parts by mass of the binder resin is the same as 100 parts by mass of a polymerizable monomer used to obtain the binder resin. In the case of core-shell type colored resin particles, 100 parts by mass of the binder resin is the same as 100 parts by mass of a polymerizable monomer used to obtain the core layer.

### (Positively-Chargeable Charge Control Resin)

As the positively-chargeable charge control resin, a combination of the copolymer A, which contains a functional group-containing monomer unit in an amount of 1.50% by mass or more and 6.00% by mass or less, and the copolymer B, which contains a functional group-containing monomer unit in an amount of 0.10% by mass or more and less than 1.50% by mass, is used.

In the copolymers A and B, the functional group-containing monomer unit is a monomer unit containing a functional group which can impart positively-chargeable property.

The functional group amount of the copolymer A is preferably 1.60% by mass or more, and more preferably 1.80% by mass or more, from the viewpoint of improving the effect of suppressing the bleeding of the release agent. On the other hand, the functional group amount of the copolymer A is preferably 4.00% by mass or less, and more preferably 3.00% by mass or less, from the point of view that the charge amount of the toner is likely to be appropriate, and especially a decrease in image density, which is caused when the charge amount of the toner is too high, is suppressed.

The functional group amount of the copolymer B is preferably 0.40% by mass or more, and more preferably 0.50% by mass or more, from the point of view that the charge amount of the toner is likely to be appropriate, and especially the occurrence of fogging, which is caused when the charge amount of the toner is too low, is suppressed. On the other hand, the functional group amount of the copolymer B is preferably 1.40% by mass or less, and more preferably 1.20% by mass or less, from the point of view that the charge amount of the toner is likely to be appropriate, and especially, a decrease in image density, which is caused when the charge amount of the toner is too high, is suppressed.

As the copolymers A and B, a copolymer containing the following monomer units is preferred: a monomer unit containing a functional group which can impart positively-chargeable property, an aromatic vinyl monomer unit, and a (meth)acrylate monomer unit. The aromatic vinyl monomer unit and (meth)acrylate monomer unit used herein do not contain a functional group which can impart positively-chargeable property. Since the copolymer has excellent compatibility with the binder resin, the charge amount of the toner is likely to be uniform.

The copolymers A and B are preferably soluble in the aromatic vinyl monomer, from the viewpoint of dispersibility into the polymerizable monomer composition.

In the present disclosure, (meth)acrylate means each of acrylate and methacrylate.

As the functional group which can impart positively-chargeable property, examples include, but are not limited to, a pyridinium group, an amino group, a quaternary ammonium group and a quaternary ammonium salt group. Preferred is a quaternary ammonium salt group, from the point of view that it effectively functions in a non-magnetic one-component developer and the charge amount of the toner is likely to be uniform.

The quaternary ammonium salt group has an ionic structure represented by —NR₃⁺·X⁻. In the ionic structure, each R is independently a hydrogen atom or a substituent such as an alkyl group, and it is preferably a hydrogen atom or a linear, branched or cyclic alkyl group containing 1 to 6 carbon atoms. Also in the ionic structure, X⁻ is a halogen ion, an alkyl group in which one hydrogen atom is substituted with a halogen ion, or a hydrocarbon group which contains —SO₃⁻, —PO₃⁻ or —BO₃⁻ and in which at least one hydrogen atom is optionally substituted with a halogen atom. As the hydrocarbon group, examples include, but are not limited to, an alkyl group, an aromatic hydrocarbon group and a substituted aromatic hydrocarbon group. From the point of view that the charge amount of the toner is likely to be retained during continuous printing and a print failure is less likely to occur, X⁻ is preferably a hydrocarbon group which contains —SO₃⁻ and in which at least one hydrogen atom is optionally substituted with a halogen atom, more preferably an aromatic sulfonate anion which optionally contains at least one substituent selected from the group consisting of a halogen atom and a linear, branched or cyclic alkyl group containing 1 to 6 carbon atoms, and still more preferably a benzenesulfonate anion or a para-toluenesulfonate anion.

Each of the copolymers A and B may be, for example, a copolymer obtained by copolymerization of a vinyl-based monomer containing a functional group which can impart positively-chargeable property and another vinyl-based monomer which is copolymerizable with this, or it may be a copolymer obtained as follows: a vinyl-based monomer not containing a functional group which can impart positively-chargeable property is polymerized, and a functional group which can impart positively-chargeable property is introduced therein by modification treatment, thereby obtaining the copolymer.

The copolymer containing the aromatic vinyl monomer unit, the (meth)acrylate monomer unit, and the monomer unit containing the quaternary ammonium salt group, which is preferably used as the copolymers A and B, is not particularly limited. For example, it can be obtained by any of the following methods.

The polymerization method is not particularly limited. For example, a known polymerization method such as emulsion polymerization, dispersion polymerization, suspension polymerization and solution polymerization can be employed.
(i) A method in which an aromatic vinyl monomer, a (meth)acrylate monomer and an N,N-disubstituted aminoalkyl (meth)acrylate monomer are copolymerized in the presence of a polymerization initiator, followed by quaternizing the amino group with a quaternizing agent such as a halogenated organic compound and an acid ester compound.
(ii) A method in which an aromatic vinyl monomer, a (meth)acrylate monomer and a monomer in which an N,N-disubstituted aminoalkyl (meth)acrylate monomer is made into a quaternary ammonium salt using a quaternizing agent such as a halogenated organic compound and an acid ester compound, are copolymerized in the presence of a polymerization initiator.

As the aromatic vinyl monomer, examples include, but are not limited to, styrene, α-methylstyrene, 2-methylstyrene, 3-methylstyrene, 4-methylstyrene, 2-ethylstyrene, 3-ethylstyrene, 4-ethylstyrene, 2-propylstyrene, 3-propylstyrene, 4-propylstyrene, 2-isopropylstyrene, 3-isopropylstyrene, 4-isopropylstyrene, 2,4-diisopropylstyrene, 2,4-dimethylstyrene, 4-butylstyrene, 4-t-butylstyrene, 5-t-butyl-2-methylstyrene, 2-chlorostyrene, 3-chlorostyrene, 4-chlorostyrene, 2-methyl-α-methylstyrene, 3-methyl-α-methylstyrene, 4-methyl-α-methylstyrene, 4-bromostyrene, 2-methyl-4,6-dichlorostyrene, 2,4-dibromostyrene and vinylnaphthalene. Of them, styrene and α-methylstyrene are preferred. These aromatic vinyl monomers may be used alone or in combination of two or more.

As the (meth)acrylate monomer, for example, an alkyl (meth)acrylate monomer optionally containing a hydroxyl group is preferably used. As the alkyl (meth)acrylate monomer optionally containing a hydroxyl group, examples include, but are not limited to, methyl (meth)acrylate, ethyl (meth)acrylate, propyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, 2-ethylhexyl (meth)acrylate, hydroxypropyl (meth)acrylate and dodecyl (meth)acrylate. They may be used alone or in combination of two or more. In the alkyl (meth)acrylate monomer, the number of the carbon atoms of the alkyl group is not particularly limited. The alkyl group preferably contains 1 to 12 carbon atoms, more preferably 1 to 8 carbon atoms, and still more preferably 1 to 6 carbon atoms. Particularly preferred is an alkyl (meth)acrylate monomer containing no substituent.

As the N,N-disubstituted aminoalkyl (meth)acrylate monomer, examples include, but are not limited to, dimethylaminomethyl (meth)acrylate, diethylaminomethyl (meth)acrylate, dipropylaminomethyl (meth)acrylate, diisopropylaminomethyl (meth)acrylate, ethylmethylaminomethyl (meth)acrylate, methylpropylaminomethyl (meth)acrylate, dimethylamino-1-ethyl (meth)acrylate, diethylamino-1-ethyl (meth)acrylate and dipropylamino-1-ethyl (meth)acrylate. They may be used alone or in combination of two or more. In the N,N-disubstituted aminoalkyl (meth)acrylate monomer, the number of the carbon atoms of the alkyl group is not particularly limited. The alkyl group preferably contains 1 to 3 carbon atoms.

As the halogenated organic compound used as the quaternizing agent, examples include, but are not limited to, a linear, branched or cyclic alkyl halide containing 1 to 6 carbon atoms, such as chloromethane, dichloromethane and trichloromethane, and an aromatic halide such as chlorobenzene, 4-chlorotoluene and 1-chloronaphthalene.

As the acid ester compound used as the quaternizing agent, examples include, but are not limited to, an alkyl sulfonic acid alkyl ester such as methyl methanesulfonate and ethyl methanesulfonate; a benzenesulfonic acid alkyl ester such as methyl benzenesulfonate; a p-toluenesulfonic acid alkyl ester such as methyl p-toluenesulfonate; a phosphoric ester such as trimethyl phosphate; and a boric acid ester such as trimethoxyborane.

These quaternizing agents may be used alone or in combination of two or more.

The quaternary ammonium salt group-containing monomer unit contained in the copolymers is preferably a constitutional unit represented by the following formula [I]:

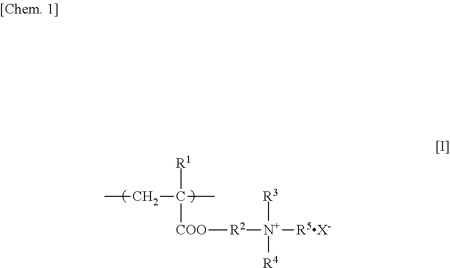

(where R¹ is a hydrogen atom or a methyl group; R² is a linear or branched alkylene group containing 1 to 3 carbon atoms, in which at least one hydrogen atom is optionally substituted with a halogen atom; each of R³ to R⁵ is independently a hydrogen atom or a linear, branched or cyclic alkyl group containing 1 to 6 carbon atoms; and X⁻ is a halogen ion or a benzene or naphthalene which contains —SO₃⁻, —PO₃⁻ or —BO₃⁻ and which optionally contains at least one substituent selected from the group consisting of a halogen atom and a linear, branched or cyclic alkyl group containing 1 to 6 carbon atoms.)

As described above, X⁻ is a halogen ion or a benzene or naphthalene which contains —SO₃⁻, —PO₃⁻ or —BO₃⁻ and which optionally contains at least one substituent selected from the group consisting of a halogen atom and a linear, branched or cyclic alkyl group containing 1 to 6 carbon atoms. From the point of view that the charge amount of the toner is likely to be retained during continuous printing and a print failure is less likely to occur, X⁻ is more preferably the above-described aromatic sulfonate anion which optionally contains the substituent. As the aromatic sulfonate anion, examples include, but are not limited to, benzenesulfonate anion and para-toluenesulfonate anion.

As the constitutional unit represented by the formula [I], examples include, but are not limited to, a constitutional unit corresponding to a quaternary ammonium salt group-containing monomer such as N,N-diethyl-N-methyl-2-(methacryloyloxy)ethylammonium chloride, 2-(methacryloyloxy)ethyltrimethylammonium chloride (DMC: dimethylaminoethyl methacrylate methyl chloride), 2-(methacryloyloxy)-N-benzyl-N,N-dimethylethaneammonium chloride (DML: dimethylaminoethyl methacrylate benzyl chloride), N,N-diethyl-N-methyl-2-(methacryloyloxy)ethylammonium p-toluenesulfonate, 2-(methacryloyloxy)ethyl trimethylammonium p-toluenesulfonate, and 2-(methacryloyloxy)-N-benzyl-N,N-dimethylethaneammonium p-toluenesulfonate. Of them, a constitutional unit corresponding to N,N-diethyl-N-methyl-2-(methacryloyloxy)ethylammonium p-toluenesulfonate is preferred.

In the copolymers, the copolymerization ratio between the aromatic vinyl monomer and the (meth)acrylate monomer is not particularly limited. From the viewpoint of solubility into the polymerizable monomer and dispersibility into the binder resin, the mass ratio of the (meth)acrylate monomer unit to the aromatic vinyl monomer unit (the (meth)acrylate monomer unit/the aromatic vinyl monomer unit) is preferably from 0.05 to 0.35, more preferably from 0.10 to 0.30, and still more preferably from 0.15 to 0.25.

In the present disclosure, there is no particular limitation on the content of the copolymer A which contains the functional group-containing monomer unit in an amount of 1.50% by mass or more and 6.00% by mass or less. With respect to 100 parts by mass of the binder resin, the content is preferably 0.50 parts by mass or more, more preferably 0.80 parts by mass or more, and still more preferably 1.00 part by mass or more, as the lower limit. On the other hand, the content is preferably 3.00 parts by mass or less, more preferably 2.50 parts by mass or less, and still more preferably 2.00 parts by mass or less, as the upper limit. When the content of the copolymer A is equal to or more than the lower limit value, the effect of suppressing the bleeding of the release agent is improved. In addition, the charge amount of the toner is likely to be appropriate, and especially the occurrence of fogging, which is caused when the charge amount of the toner is too low, is suppressed. When the content of the copolymer A is equal to or less than the upper limit value, the charge amount of the toner is likely to be appropriate, and especially a decrease in image density, which is caused when the charge amount of the toner is too high, is suppressed.

In the present disclosure, there is no particular limitation on the content of the copolymer B which contains the functional group-containing monomer unit in an amount of 0.10% by mass or more and less than 1.50% by mass. With respect to 100 parts by mass of the binder resin, the content is preferably 0.50 parts by mass or more, more preferably 0.60 parts by mass or more, and still more preferably 0.80 parts by mass or more, as the lower limit. On the other hand, the content is preferably 5.00 parts by mass or less, more preferably 3.00 parts by mass or less, and still more preferably 2.00 parts by mass or less, as the upper limit. When the content of the copolymer B is equal to or more than the lower limit value, the effect of suppressing the bleeding of the release agent is improved. When the content of the copolymer B is equal to or less than the upper limit value, the charge amount of the toner is likely to be appropriate, and especially a decrease in image density, which is caused when the charge amount of the toner is too high, is suppressed.

The ratio of the content of the copolymer A to the content of the copolymer B (the copolymer A content/the copolymer B content) is not particularly limited. The ratio is preferably 0.3 or more, more preferably 0.5 or more, and still more preferably 1.0 or more, as the lower limit. On the other hand, the ratio is preferably 3.0 or less, more preferably 2.5 or less, and still more preferably 2.0 or less, as the upper limit.

When the ratio (the copolymer A content/the copolymer B content) is equal to or more than the lower limit value and equal to or less than the upper limit value, the effect of suppressing the bleeding of the release agent is improved, and the charge amount of the toner is likely to be appropriate. Especially, when the ratio is equal to or more than the lower limit value, the occurrence of fogging, which is caused when the charge amount of the toner is too low, is suppressed. When the ratio is equal to or less than the upper limit value, a decrease in image density, which is caused when the charge amount of the toner is too high, is suppressed.

In the present disclosure, as the positively-chargeable charge control resin, at least one kind of copolymer A and at least one kind of copolymer B are only required to be contained. From the viewpoint of easily obtaining the effects of the present disclosure, each of the copolymer A and the copolymer B is preferably composed of copolymers having the same monomer unit composition. The copolymers having the same monomer unit composition mean that the type of monomers used for polymer synthesis and the copolymerization ratio thereof, are the same among the copolymers.

In the present disclosure, the sum of the products of F and m (F×m) calculated for each of the copolymers contained as the positively-chargeable charge control resin, is preferably 1.80 or more and 6.00 or less, and more preferably 2.00 or more and 6.00 or less when, in each of the copolymers, the amount (% by mass) of the functional group-containing monomer unit is represented as F, and the content (parts by mass) of the copolymer with respect to 100 parts by mass of the binder resin is represented as m. That is, for example, when one kind of copolymer A and one kind of copolymer B are contained as the positively-chargeable charge control resin, the amount (% by mass) of the functional group-containing monomer unit of the copolymer A is F_{A}; the content (parts by mass) of the copolymer A with respect to 100 parts by mass of the binder resin is m_{A}; the amount (% by mass) of the functional group-containing monomer unit of the copolymer B is F_{B}; and the content (parts by mass) of the copolymer B with respect to 100 parts by mass of the binder resin is m_{B}. In this case, the sum (F_{A}×m_{A}+F_{B}×m_{B}) of the product of F_{A} and m_{A} (F_{B}×m_{A}) calculated for the copolymer A and the product of F_{B} and m_{B} (F_{B}×m_{B}) calculated for the copolymer B is preferably 1.80 or more and 6.00 or less, and more preferably 2.00 or more and 6.00 or less. When the sum of the products is equal to or more than the lower limit value, since the charge amount of the toner is sufficiently high, and the occurrence of fogging is suppressed. When the sum of the products is equal to or less than the upper limit value, since the charge amount of the toner is not too high, a decrease in image density is suppressed. Also when the sum of the products is equal to or less than the upper limit value, since the amount of the charge control resin present on the surface of the colored resin particles is not too large and since a sufficient amount of the polar resin is unevenly distributed on the surface of the colored resin particles, the heat resistance of the toner and the effect of suppressing the bleeding of the release agent are improved, and the occurrence of fogging is suppressed when the toner is used after long-time storage in a high-temperature and high-humidity environment.

The above-described sum of the products of F and m (F×m) calculated for each of the copolymers is still more preferably 2.50 or more, and even more preferably 3.00 or more, as the lower limit. On the other hand, the sum is still more preferably 5.50 or less, and even more preferably 5.00 or less, as the upper limit.

There is no particular limitation on the difference (F_{A}−F_{B}) between the amount F_{A} (% by mass) of the functional group-containing monomer unit of the copolymer A and the amount F_{B} (% by mass) of the functional group-containing monomer unit of the copolymer B. From the viewpoint of easily obtaining the effects of the present disclosure, the difference is preferably 0.30 or more, more preferably 0.50 or more, and still more preferably 0.70 or more as the lower limit, and on the other hand, the difference is preferably 5.90 or less, more preferably 5.00 or less, and still more preferably 1.50 or less, as the upper limit.

When several kinds of copolymers A are contained, one having the largest functional group amount is selected, and its functional group amount value is used as F_{A} for the calculation of the difference (F_{A}−F_{B}). When several kinds of copolymers B are contained, one having the smallest functional group amount is selected, and its functional group amount value is used as F_{B} for the calculation of the difference (F_{A}−F_{B}).

The weight average molecular weight (Mw) of the copolymers A and B is not particularly limited, and it is preferably from 8,000 to 28,000, more preferably from 10,000 to 25,000, and still more preferably from 15,000 to 23,000. When the weight average molecular weight (Mw) is equal to or more than the lower limit value, a decrease in storage stability or printing durability can be suppressed. When the weight average molecular weight (Mw) is equal to or less than the upper limit value, a decrease in fixability can be suppressed. In addition, when the weight average molecular weight (Mw) is within the above range, the charge control resin can be appropriately dispersed in the polymerizable monomer composition, and the toner having a charge amount that is stable over time, is easily obtained.

In the present disclosure, the weight average molecular weight Mw is a polystyrene equivalent measured by gel permeation chromatography (GPC) using tetrahydrofuran.

The polymerizable monomer composition may further contain a charge control agent which is different from the copolymer A or B, to the extent that does not impair the effects of the present disclosure. In this case, since the effects of the present disclosure are easily obtained, in the total amount (100 parts by mass) of the charge control agent, the content of the copolymers A and B is preferably 90 parts by mass or more, more preferably 95 parts by mass or more, and still more preferably 99 parts by mass or more.

### (Polar Resin)

As the polar resin, a resin having an acid value of 0.5 mgKOH/g or more and 8.0 mgKOH/g or less is used, and a resin having an acid value of 0.5 mgKOH/g or more and 5.0 mgKOH/g or less is preferably used.

From the viewpoint of suppressing a print failure in a high-temperature and high-humidity environment, an acidic group-containing, acrylate-based copolymer is preferably used as the polar resin. As the acidic group-containing, acrylate-based copolymer, for example, a copolymer of a (meth)acrylic ester and (meth)acrylic acid is preferably used.

In the present disclosure, (meth)acryl means each of acryl and methacryl. The copolymer of a (meth)acrylic ester and (meth)acrylic acid is a copolymer of at least one selected from the group consisting of an acrylic ester and a methacrylic ester and at least one selected from the group consisting of acrylic acid and methacrylic acid.

As the copolymer, examples include, but are not limited to, a copolymer of an acrylic ester and acrylic acid, a copolymer of an acrylic ester and methacrylic acid, a copolymer of a methacrylic ester and acrylic acid, a copolymer of a methacrylic ester and methacrylic acid, a copolymer of an acrylic ester, a methacrylic ester and acrylic acid, a copolymer of an acrylic ester, a methacrylic ester and methacrylic acid, and a copolymer of an acrylic ester, a methacrylic ester, acrylic acid and methacrylic acid. Of them, preferred is a copolymer of an acrylic ester, a methacrylic ester and acrylic acid.

As the (meth)acrylic ester, examples include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, n-pentyl (meth)acrylate, sec-pentyl (meth)acrylate, isopentyl (meth)acrylate, neopentyl (meth)acrylate, n-hexyl (meth)acrylate, isohexyl (meth)acrylate, neohexyl (meth)acrylate, sec-hexyl (meth)acrylate and tert-hexyl (meth)acrylate.

As the acrylic ester, ethyl acrylate, n-propyl acrylate, isopropyl acrylate and n-butyl acrylate are preferred, and ethyl acrylate and n-butyl methacrylate are more preferred.

As the methacrylic ester, methyl methacrylate, n-propyl methacrylate, isopropyl methacrylate and n-butyl methacrylate are preferred, and methyl methacrylate is more preferred.

The mass ratio of the monomer units of the acrylate-based copolymer is preferably adjusted so that the acid value, weight average molecular weight Mw and glass transition temperature described below are satisfied.

Of 100% by mass of all the monomer units constituting the acrylate-based copolymer, the content of the (meth)acrylic acid unit is preferably 0.05% by mass or more, more preferably 0.1% by mass or more, and still more preferably 0.3% by mass or more, as the lower limit. On the other hand, the content is preferably 1.0% by mass or less, more preferably 0.6% by mass or less, and still more preferably 0.5% by mass or less, as the upper limit.

Of 100% by mass of all the monomer units constituting the acrylate-based copolymer, the content of the (meth)acrylic ester unit is preferably 99.0% by mass or more, more preferably 99.4% by mass or more, and still more preferably 99.5% by mass or more, as the lower limit. On the other hand, the content is preferably 99.95% by mass or less, more preferably 99.9% by mass or less, and still more preferably 99.7% by mass or less, as the upper limit.

To the extent that does not impair the effects of the present disclosure, the acrylate-based copolymer may contain another monomer unit different from the (meth)acrylic acid unit and the (meth)acrylic acid unit. As the another monomer, examples include, but are not limited to, the styrene derivative, nitrile compound and amide compound exemplified above as the monovinyl monomer constituting the binder resin.

In the acrylate-based copolymer, the content of the another monomer unit is preferably 10 parts by mass or less, more preferably 2 parts by mass or less, and most preferably 0 part by mass, with respect to 100 parts by mass of the (meth)acrylic ester unit.

The acid value of the polar resin is only required to be 0.5 mgKOH/g or more and 8.0 mgKOH/g or less, and it is preferably 0.5 mgKOH/g or more and 5.0 mgKOH/g or less. The acid value of the polar resin is more preferably 1.0 mgKOH/g or more, and still more preferably 2.0 mgKOH/g or more, as the lower limit. On the other hand, the acid value of the polar resin is more preferably 4.0 mgKOH/g or less, and still more preferably 3.0 mgKOH/g or less, as the upper limit. When the acid value of the polar resin is equal to or more than the lower limit value, the charge amount of the toner can be appropriately decreased, and a decrease in image density can be suppressed, accordingly. When the acid value of the polar resin is equal to or less than the upper limit value, a fluctuation in the charge amount of the toner, which is involved in temperature and humidity changes, is suppressed.

In the present disclosure, the acid value of the resin is measured according to JIS K 0070.

The weight average molecular weight (Mw) of the polar resin is not particularly limited. The weight average molecular weight of the polar resin is preferably 6,000 or more, more preferably 7,000 or more, and still more preferably 9,000 or more, as the lower limit. On the other hand, the weight average molecular weight is preferably 50,000 or less, more preferably 45,000 or less, and still more preferably 40,000 or less, as the upper limit thereof.

When the weight average molecular weight (Mw) of the polar resin is equal to or more than the lower limit value, the effect of suppressing the bleeding of the release agent is improved. When the weight average molecular weight (Mw) of the polar resin is equal to or less than the upper limit value, a decrease in the heat resistance of the toner is suppressed, and the occurrence of fogging is suppressed when the toner is used after long-time storage in a high-temperature and high-humidity environment.

The glass transition temperature Tg of the polar resin is not particularly limited. The glass transition temperature of the polar resin is preferably 60° C. or more, more preferably 65° C. or more, and still more preferably 70° C. or more, as the lower limit. On the other hand, the glass transition temperature is preferably 85° C. or less, more preferably 80° C. or less, and still more preferably 77° C. or less, as the upper limit.

When the glass transition temperature Tg of the polar resin is within the above range, a decrease in the heat resistance of the toner is suppressed, and the occurrence of fogging is suppressed when the toner is used after long-time storage in a high-temperature and high-humidity environment.

In the present disclosure, the grass transition temperature Tg can be obtained according to ASTM D3418-82.

The content of the polar resin is preferably 0.30 parts by mass or more, more preferably 0.40 parts by mass or more, and still more preferably 0.50 parts by mass or more, as the lower limit, with respect to 100 parts by mass of the binder resin. On the other hand, the content is preferably 3.00 parts by mass or less, more preferably 2.00 parts by mass or less, and still more preferably 1.50 parts by mass or less, as the upper limit, with respect to 100 parts by mass of the binder resin.

When the content of the polar resin is equal to or more than the lower limit value, the effect of suppressing the bleeding of the release agent is improved. When the content of the polar resin is equal to or less than the upper limit value, the charge amount of the toner is likely to be appropriate, and especially the occurrence of fogging, which is caused when the charge amount of the toner is too low, is suppressed; moreover, a fluctuation in the charge amount of the toner, which is involved in temperature and humidity changes, is suppressed.

A commercially-available product can be used as the polar resin, or the polar resin can be produced by a known polymerization method such as solution polymerization, aqueous solution polymerization, ionic polymerization, high-temperature and high-pressure polymerization and suspension polymerization.

A typical example of the method for producing the polar resin is as described below. Note that the polar resin production method is not limited to the following typical example.

First, a solvent is put in a reaction container as appropriate. After the atmosphere inside the reaction container is replaced by an inert atmosphere, the temperature of the inside of the reaction container is increased, and a raw material monomer is put in the reaction container. At this time, a polymerization initiator is preferably added in combination with the raw material monomer. It is also preferable to put the mixture of the raw material monomer and the polymerization initiator in a dropwise manner in the reaction container. Next, the temperature of the contents of the reaction container is increased to a temperature at which a polymerization reaction is developed, thereby initiating polymerization. After the polymerization is completed, the solvent is removed by distillation as appropriate, thereby obtaining the desired polar resin.

The absolute value (|X×m_{P}−F_{A}×m_{A}|) of the difference between the product of X and mₚ (X×m_{P}) and the product of F_{A} and m_{A} (F_{A}×m_{A}) is preferably 2.50 or less, when the acid value (mgKOH/g) of the polar resin is represented as X; the content (parts by mass) of the polar resin with respect to 100 parts by mass of the binder resin is represented as m_{P}; the amount (% by mass) of the functional group-containing monomer unit in the copolymer A is represented as F_{A}; and the content (parts by mass) of the copolymer A with respect to 100 parts by mass of the binder resin is represented as m_{A}. Accordingly, a fluctuation in the charge amount of the toner, which is involved in temperature and humidity changes, is suppressed. The absolute value (|X×m_{P}−F_{A}×m_{A}|) of the difference is more preferably 2.00 or less, and still more preferably 1.00 or less. The lower limit is not particularly limited, and it may be 0. For example, it may be 0.20 or more.

When several kinds of polar resins are contained, “X×m_{P}” used in the formula is the sum of the products of “X×m_{P}” calculated for each of the polar resins. When several kinds of copolymers A are contained, “F_{A}×m_{A}” used in the formula is the sum of the products of “F_{A}×m_{A}” calculated for each of the copolymers A.

### (Styrene-Based Thermoplastic Elastomer)

The polymerizable monomer composition preferably contains the styrene-based thermoplastic elastomer. This results in an improvement of the dispersibility of the release agent, and the bleeding of the release agent is less likely to occur, accordingly.

In the present disclosure, the styrene-based thermoplastic elastomer means a copolymer of a styrene-based monomer (that is, an aromatic vinyl monomer) and another monomer which is copolymerizable with the aromatic vinyl monomer, such as a random copolymer, a block copolymer, a graft copolymer or the like, and hydrogenated products of such a copolymer.

A thermoplastic elastomer is typically such a material, that when the original volume is considered as 100% by volume, it can be deformed to a volume of 200% by volume by applying small external force at room temperature (20° C.), and when the small force is removed from the material, the material volume returns to less than 130% by volume.

As the styrene-based thermoplastic elastomer, for example, a conjugated diene-aromatic vinyl-based thermoplastic elastomer is preferably used. Particularly preferred is a non-hydrogenated conjugated diene-aromatic vinyl-based thermoplastic elastomer. The conjugated diene-aromatic vinyl-based thermoplastic elastomer is a polymer containing a constitutional unit derived from a conjugated diene monomer and a constitutional unit derived from an aromatic vinyl monomer.

As the conjugated diene-aromatic vinyl-based thermoplastic elastomer, examples include, but are not limited to, a copolymer of a conjugated diene monomer, an aromatic vinyl monomer and, as needed, another monomer which is copolymerizable with them, such as a random copolymer, a block copolymer, a graft copolymer or the like, and hydrogenated products of such copolymer. Of them, a block copolymer containing at least one aromatic vinyl polymer block and at least one conjugated diene polymer block is preferred for better fixability of the toner.

Hereinafter, a representative example of the styrene-based thermoplastic elastomer will be described, which is a block copolymer containing at least one aromatic vinyl polymer block and at least one conjugated diene polymer block (hereinafter, it may be simply referred to as “block copolymer”). The block copolymer contains at least one aromatic vinyl polymer block, which is obtained by polymerizing an aromatic vinyl monomer, and at least one conjugated diene polymer block, which is obtained by polymerizing a conjugated diene monomer.

As the aromatic vinyl monomer used in the aromatic vinyl polymer block, examples include, but are not limited to, those exemplified above as the aromatic vinyl monomer applicable to the charge control resin, and styrene is preferred. In each aromatic vinyl polymer block contained in the block copolymer, the aromatic vinyl monomers may be used alone or in combination of two or more. When the block copolymer contains several aromatic vinyl polymer blocks, each of the aromatic vinyl polymer blocks may be composed of the same aromatic vinyl monomer units, or it may be composed of different aromatic vinyl monomer units.

The aromatic vinyl polymer block may contain other monomer units, as long as the aromatic vinyl monomer unit is a main repeating unit. Other monomers applicable to the aromatic vinyl polymer block are, for example, a conjugated diene monomer (such as 1,3-butadiene and isoprene (2-methyl-1,3-butadiene)), an α,β-unsaturated nitrile monomer, an unsaturated carboxylic acid or acid anhydride monomer, an unsaturated carboxylic acid ester monomer and a non-conjugated diene monomer. In the aromatic vinyl polymer block, the content of the monomer units other than the aromatic vinyl monomer unit is preferably 20% by mass or less, more preferably 10% by mass or less, and particularly preferably 0% by mass.

As the conjugated diene monomer used in the conjugated diene polymer block, examples include, but are not limited to, 1,3-butadiene, isoprene, 2,3-dimethyl-1,3-butadiene, 2-chloro-1,3-butadiene, 1,3-pentadiene and 1,3-hexadiene. Of them, at least one selected from the group consisting of 1,3-butadiene and isoprene is preferred, and isoprene is particularly preferred, from the point of view that the effect of improving storage stability and low-temperature fixability is high. In each conjugated diene polymer block contained in the block copolymer, these conjugated diene monomers may be used alone or in combination of two or more. When the block copolymer contains several conjugated diene polymer blocks, each of the conjugated diene polymer blocks may be composed of the same conjugated diene monomer units, or it may be composed of different conjugated diene monomer units. In addition, a part of the unsaturated bonds of each conjugated diene polymer block may be subjected to a hydrogenation reaction.

The conjugated diene polymer block may contain other monomer units, as long as the conjugated diene monomer unit is a main repeating unit. Other monomers applicable to the conjugated diene polymer block are, for example, an aromatic vinyl monomer (such as styrene and α-methylstyrene), an α,β-unsaturated nitrile monomer, an unsaturated carboxylic acid monomer, an unsaturated carboxylic anhydride monomer, an unsaturated carboxylic acid ester monomer and a non-conjugated diene monomer. In the conjugated diene polymer block, the content of the monomer units other than the conjugated diene monomer unit is preferably 20% by mass or less, more preferably 10% by mass or less, and particularly preferably 0% by mass.

The content of a vinyl bond in the conjugated diene polymer block (the percentage of a 1,2-vinyl bond unit and a 3,4-vinyl bond unit in all the conjugated diene monomer units of the conjugated diene polymer block) is not particularly limited. It is preferably from 1 mol % to 20 mol %, more preferably from 2 mol % to 15 mol %, and particularly preferably from 3 mol % to 10 mol %.

In the block copolymer, the number and binding form of the polymer blocks are not particularly limited, as long as the block copolymer contains at least one aromatic vinyl polymer block and at least one conjugated diene polymer block. As the block copolymer, examples include, but are not limited to, the following. In the following examples, Ar represents the aromatic vinyl polymer block; D represents the conjugated diene polymer block; X represents the residue of a coupling agent; and n represents an integer of 2 or more.
(a) An aromatic vinyl-conjugated diene block copolymer represented by Ar-D
(b) An aromatic vinyl-conjugated diene-aromatic vinyl block copolymer represented by Ar-D-Ar or (Ar-D)ₙ-X
(c) A conjugated diene-aromatic vinyl-conjugated diene block copolymer represented by D-Ar-D or (D-Ar)ₙ-X
(d) An aromatic vinyl-conjugated diene-aromatic vinyl-conjugated diene block copolymer represented by Ar-D-Ar-D
(e) A block copolymer composition that is a combination of any two or more of the above block copolymers (a) to (d)

From the viewpoint of better fixability, the toner of the present disclosure preferably contains at least the block copolymer (b), and more preferably at least the block copolymers (a) and (b), as the styrene-based thermoplastic elastomer.

When the block copolymer (b) is contained as the styrene-based thermoplastic elastomer, with respect to 100% by mass of the styrene-based thermoplastic elastomer, the content of the block copolymer (b) is preferably 2% by mass or more, and more preferably 5% by mass or more, as the lower limit. On the other hand, the content is preferably 60% by mass or less, and more preferably 50% by mass or less, as the upper limit.

When the block copolymer (a) is contained as the styrene-based thermoplastic elastomer, with respect to 100% by mass of the styrene-based thermoplastic elastomer, the content of the block copolymer (a) is preferably 40% by mass or more, more preferably 50% by mass or more, and still more preferably 55% by mass or more, as the lower limit. On the other hand, the upper limit is not particularly limited, and the content is preferably 98% by mass or less, and more preferably 95% by mass or less.

When the block copolymers (a) and (b) are contained as the styrene-based thermoplastic elastomer, with respect to the total mass (100 parts by mass) of the block copolymers (a) and (b), the content of the block copolymer (b) is preferably from 2 parts by mass to 60 parts by mass, and more preferably from 5 parts by mass to 50 parts by mass.

When the content of the block copolymer (a) and that of the block copolymer (b) are within the above ranges, the fixability of the toner improves, and a decrease in image density is suppressed, accordingly; moreover, the charge amount of the toner is likely to be appropriate, and the bleeding of the release agent is likely to be suppressed, accordingly.

In the block copolymer (a), the weight average molecular weight (Mw(Ar)) of the aromatic vinyl polymer block Ar is not particularly limited. The weight average molecular weight (Mw(Ar)) is preferably from 10000 to 50000, and more preferably from 15000 to 30000.

Also in the block copolymer (a), the weight average molecular weight (Mw(D)) of the conjugated diene polymer block D is not particularly limited. The weight average molecular weight (Mw(D)) is preferably from 50000 to 200000, and more preferably from 60000 to 150000.

In the block copolymer (b), the weight average molecular weight (Mw(Ar)) of the aromatic vinyl polymer block Ar is not particularly limited. The weight average molecular weight (Mw(Ar)) is preferably from 20000 to 70000, and more preferably from 25000 to 50000.

Also in the block copolymer (b), the weight average molecular weight (Mw(D)) of the conjugated diene polymer block D is not particularly limited. The weight average molecular weight (Mw(D)) is preferably from 100000 to 300000, and more preferably from 120000 to 250000.

In the block copolymer, the content rate of the aromatic vinyl monomer unit with respect to all the monomer units is preferably from 10% by mass to 30% by mass, more preferably from 12% by mass to 25% by mass, and still more preferably from 15% by mass to 25% by mass. By adjusting the content rate of the aromatic vinyl monomer unit within the above range, the affinity of the block copolymer for the release agent can be highly balanced with the affinity of the block copolymer for the binder resin, and the toner thus obtained can be a toner having improved storage stability and low-temperature fixability.

When all of the polymer components constituting the block copolymer are only the aromatic vinyl monomer unit and the conjugated diene monomer unit, the content of the aromatic vinyl monomer unit in the block copolymer can be easily measured as follows, according to the method described in Rubber Chem. Technol., 45, 1295(1972). First, the block copolymer is oxidized by ozone. Then, the ozone-oxidized block copolymer is deoxidized with lithium aluminum hydride to decompose the conjugated diene monomer unit moiety, thereby obtaining only the aromatic vinyl monomer unit moiety. Accordingly, the whole content of the aromatic vinyl monomer unit can be easily measured.

In the block copolymer, the weight average molecular weight (Mw) of the aromatic vinyl polymer block is not particularly limited. The weight average molecular weight (Mw) is preferably from 10000 to 50000, and more preferably from 20000 to 40000.

In the block copolymer, the weight average molecular weight (Mw) of the conjugated diene polymer block is not particularly limited. The weight average molecular weight (Mw) is preferably from 50000 to 200000, and more preferably from 60000 to 180000.

The melt index (MI) of the block copolymer is not particularly limited. As a value measured according to ASTM D-1238 (in condition G, 200° C., 5 kg), for example, it is selected in a range of from 1 g/10 min to 1000 g/10 min, and it is preferably from 5 g/10 min to 30 g/10 min.

The block copolymer can be produced by a conventional method. As the block copolymer production method, examples include, but are not limited to, the following method: by anionic living polymerization, the aromatic vinyl monomer and the conjugated diene monomer are sequentially polymerized to form polymer blocks, and they are coupled by reaction with a coupling agent as needed, thereby producing the block copolymer.

A mixture containing at least the block copolymers (a) and (b), which is preferably used as the block copolymer, can be produced by the following method, for example.

First, by anionic living polymerization, the aromatic vinyl monomer is polymerized, and following this, the conjugated diene monomer is added thereto and polymerized, thereby obtaining a diblock copolymer having active terminals. Next, a coupling agent is added thereto, which is in an amount of less than 1 molar equivalent with respect to the active terminals of the diblock copolymer having the active terminals, to initiate a coupling reaction of a part of the diblock copolymer having the active terminals, thereby obtaining an aromatic vinyl-conjugated diene-aromatic vinyl block copolymer represented by (Ar-D)ₙ-X. Then, by adding a polymerization inhibitor, the residual diblock copolymer having the active terminals is deactivated, thereby obtaining the diblock copolymer represented by Ar-D. At this time, by using a difunctional coupling agent (such as dichlorosilane, monomethyldichlorosilane, dimethyldichlorosilane, diphenyldimethoxysilane, diphenyldiethoxysilane, dichloroethane, dibromoethane, methylene chloride and dibromomethane) as the coupling agent, an aromatic vinyl-conjugated diene-aromatic vinyl block copolymer represented by Ar-D-Ar (D contains the residue of the coupling agent) can be obtained.

As the styrene-based thermoplastic elastomer, instead of the block copolymer described above, the random copolymer of the aromatic vinyl monomer and the conjugated diene monomer can be used. The random copolymer of the aromatic vinyl monomer and the conjugated diene monomer can be produced by, for example, living anionic polymerization using an organic alkali metal compound as a polymerization initiator.

As the organic alkali metal compound, examples include, but are not limited to, an organic lithium compound, an organic sodium compound and an organic potassium compound. More specifically, examples include, but are not limited to, an organic monolithium compound such as n-butyllithium, sec-butyllithium, t-butyllithium, hexyllithium, phenyllithium and stilbene lithium; an organic polylithium compound such as dilithiomethane, 1,4-dilithiobutane, 1,4-dilithio-2-ethylcyclohexane, 1,3,5-trilithiobenzene and 1,3,5-tris(lithiomethyl)benzene; an organic sodium compound such as sodium naphthalene; and an organic potassium compound such as potassium naphthalene. Of these organic metal compounds, n-butyllithium is preferred.

In the random copolymer of the aromatic vinyl monomer and the conjugated diene monomer, the content rate of the aromatic vinyl monomer unit with respect to all the monomer units is not particularly limited, and the content is preferably 50% by mass or less, more preferably 45% by mass or less, and still more preferably 40% by mass or less. By adjusting the content rate of the aromatic vinyl monomer unit to the upper limit value or less, the affinity of the random copolymer for the release agent can be highly balanced with the affinity of the block copolymer for the binder resin, and the toner thus obtained can be a toner having improved storage stability and low-temperature fixability.

The weight average molecular weight (Mw) of the styrene-based thermoplastic elastomer is not particularly limited. The weight average molecular weight (Mw) is preferably from 60,000 to 350,000, and more preferably from 80,000 to 250,000. When the weight average molecular weight (Mw) of the styrene-based thermoplastic elastomer is within the above range, the storage stability and low-temperature fixability of the toner is improved, and the occurrence of a print failure can be suppressed.

With respect to 100 parts by mass of the binder resin, the content of the styrene-based thermoplastic elastomer is preferably 1 part by mass or more, more preferably 2 parts by mass or more, and still more preferably 3 parts by mass or more, as the lower limit. On the other hand, the content is preferably 10 parts by mass or less, and more preferably 8 parts by mass or less, as the upper limit.

When the content of the styrene-based thermoplastic elastomer is equal to or more than the lower limit value, the effect of suppressing the bleeding of the release agent improves. When the content of the styrene-based thermoplastic elastomer is equal to or less than the upper limit value, the toner is likely to spread when fixed, and a decrease in image density is suppressed, accordingly.

### (Release Agent)

As the release agent, a compound that is generally used as a release or softening agent for toners can be used without particular limitation. The fatty acid ester compound which has a number average molecular weight (Mn) of 500 or more and less than 2,000 is preferred from the following point of view: the effect of suppressing the bleeding thereof is likely to be effectively exerted by the above-described combination of the positively-chargeable charge control resin and the polar resin.

The term “fatty acid ester compound” means a product produced by an ester reaction between at least one kind of alcohol selected from the group consisting of monohydric alcohol and polyhydric alcohol and at least one kind of fatty acid selected from the group consisting of saturated fatty acid and unsaturated fatty acid.

As the monohydric alcohol, examples include, but are not limited to, a monohydric saturated aliphatic alcohol such as methanol, ethanol, 1-propanol, 2-propanol, 1-butanol, 2-butanol, 1-pentanol, 1-hexanol, octanol, 2-ethyl-1-hexanol, nonyl alcohol, lauryl alcohol, cetyl alcohol, stearyl alcohol and behenyl alcohol; a monohydric unsaturated aliphatic alcohol such as allyl alcohol, methallyl alcohol, crotyl alcohol and oleyl alcohol; a monohydric alicyclic alcohol such as cyclohexanol; and a monohydric aromatic alcohol such as phenol, phenylmethanol (benzyl alcohol), methylphenol (cresol), p-ethylphenol, dimethylphenol (xylenol), nonylphenol, dodecylphenol, phenylphenol and naphthol.

As the polyhydric alcohol, examples include, but are not limited to, a dihydric saturated aliphatic alcohol such as ethylene glycol and propylene glycol; a dihydric aromatic alcohol such as catechol and hydroquinone; and a trihydric or higher saturated aliphatic alcohol such as glycerol, pentaerythritol, dipentaerythritol and polyglycerol.

Of these monohydric and polyhydric alcohols, monohydric to tetrahydric saturated aliphatic alcohols are preferred, and behenyl alcohol and pentaerythritol are particularly preferred.

The number of the carbon atoms of the fatty acid, which is used as a raw material of the fatty acid ester compound, is preferably 12 or more, more preferably 14 or more, and still more preferably 16 or more, as the lower limit. On the other hand, it is preferably 24 or less, more preferably 22 or less, and still more preferably 18 or less, as the upper limit. When the number of the carbon atoms of the fatty acid is equal to or more than the lower limit value, the bleeding of the fatty acid ester compound is likely to be suppressed. When the number of the carbon atoms of the fatty acid is equal to or less than the upper limit value, a decrease in the heat resistance of the toner is suppressed, and the occurrence of fogging is suppressed when the toner is used after long-time storage in a high-temperature and high-humidity environment.

In addition, from the point of view that the fatty acid ester compound which has a number average molecular weight (Mn) of 500 or more and less than 2,000 is likely to be obtained, such a saturated fatty acid is particularly preferred, that the number of the carbon atoms it has is within the above range.

The saturated fatty acid is not particularly limited. As the saturated fatty acid, examples include, but are not limited to, lauric acid (12 carbon atoms), myristic acid (14 carbon atoms), pentadecylic acid (15 carbon atoms), palmitic acid (16 carbon atoms), margaric acid (17 carbon atoms), stearic acid (18 carbon atoms), arachidic acid (20 carbon atoms) and behenic acid (22 carbon atoms). Of them, behenic acid (22 carbon atoms), stearic acid (18 carbon atoms) and arachidic acid (20 carbon atoms) are preferred.

The unsaturated fatty acid is not particularly limited. As the unsaturated fatty acid, examples include, but are not limited to, the following fatty acids.
Palmitoleic acid (CH₃(CH₂)₅CH═CH(CH₂)₇COOH)
Oleic acid (CH₃(CH₂)₇CH═CH(CH₂)₇COOH)
Vaccenic acid (CH₃(CH₂)₅CH═CH(CH₂)₉COOH)
Linoleic acid (CH₃(CH₂)₃(CH₂CH═CH)₂(CH₂)₇COOH)
(9,12,15)-Linolenic acid (CH₃(CH₂CH═CH)₃(CH₂)₇COOH)
(6,9,12)-Linolenic acid (CH₃(CH₂)₃(CH₂CH═CH)₃(CH₂)₄COOH)
Eleostearic acid (CH₃(CH₂)₃(CH═CH)₃(CH₂)₇COOH)
Arachidonic acid (CH₃(CH₂)₃(CH₂CH═CH)₄(CH₂)₃COOH)

These fatty acids may be used alone or in combination of two or more.

The fatty acid ester compound preferably has an esterification rate of 92% or more, more preferably 95% or more, and still more preferably 97% or more, from the viewpoint of improving the low-temperature fixability of the toner by the sharp meltability of the fatty acid ester compound.

The esterification rate of the fatty acid ester compound is the percentage of the number of a hydroxyl group to which fatty acid is esterified, among the total number of hydroxyl groups contained in the raw material alcohol of the fatty acid ester compound. The esterification rate of the fatty acid ester compound can be obtained by measuring the saponification value (SV), hydroxyl value (OHV) and acid value (AV) of the fatty acid ester compound and calculating the esterification rate by the following formula.

$$Esterification rate ( \% ) = [ ( SV - AV ) / ( SV - AV + OHV ) ] \times 100$$

The saponification value (SV) and acid value (AV) of the fatty acid ester compound are measured according to JIS K 0070. The hydroxyl value (OHV) of the fatty acid ester compound is measured according to JIS K 1557.

The fatty acid ester compound may be any one of a monoester, a diester, a triester, a tetraester and a polyester. From the viewpoint of improving the storage stability of the toner and suppressing the aggregation of the toner in a high-temperature and high-humidity environment, a monoester is preferred. Since toner aggregates are loaded on a developing roller in an uncharged state and cause fogging, the occurrence of fogging can be suppressed by suppressing toner aggregation. Although a monoester is generally likely to bleed out, the bleeding of the release agent is suppressed in the toner of the present disclosure. Hence, the effects of the present disclosure are particularly effectively exerted by using a monoester as the release agent.

As the monoester, examples include, but are not limited to, behenyl palmitate, behenyl stearate, behenyl eicosanoate, behenyl behenate, eicosyl palmitate, eicosyl stearate, eicosyl eicosanoate, eicosyl behenate, stearyl stearate, stearyl eicosanoate, stearyl behenate, hexadecyl eicosanoate and hexadecyl behenate. Of them, behenyl stearate, behenyl palmitate and stearyl behenate are preferred, and behenyl stearate is particularly preferred, from the point of view that the low-temperature fixability of the toner is improved, and that the toner is likely to be dissolved and spread when fixed, increasing a covering rate on paper and resulting in an increase in image density, accordingly.

The number average molecular weight (Mn) of the fatty acid ester compound is preferably 500 or more, and more preferably 550 or more, as the lower limit, from the viewpoint of improving the low-temperature fixability of the toner and suppressing the bleeding of the fatty acid ester compound. On the other hand, the number average molecular weight (Mn) of the fatty acid ester compound is preferably less than 2,000, more preferably 1,500 or less, still more preferably 1,000 or less, and even more preferably 700 or less, from the point of view that the toner is likely to spread when fixed, and a decrease in image density is suppressed.

Although the fatty acid ester compound having a number average molecular weight (Mn) within the above range, is likely to bleed out, the bleeding of the release agent is suppressed in the toner of the present disclosure. Hence, the effects of the present disclosure are particularly effectively exerted by using the fatty acid ester compound having a number average molecular weight (Mn) within the above range as the release agent.

The release agent preferably has a melting point of preferably in a range of from 50° C. to 90° C., more preferably in a range of from 60° C. to 85° C., and still more preferably in a range of from 65° C. to 75° C.

As the fatty acid ester compound, a commercially-available product can be used, such as WEP2, WEP3, WEP4, WEP5, WE6 and WE11 (product names) manufactured by NOF Corporation.

In the present disclosure, another release agent can be used in combination with the fatty acid ester compound. As the release agent, examples include, but are not limited to, low-molecular-weight polyolefin wax and modified wax thereof; natural plant wax such as jojoba; petroleum wax such as paraffin; mineral wax such as ozokerite; and synthetic wax such as Fischer-Tropsch wax. These release agents may be used alone or in combination of two or more.

With respect to 100 parts by mass of the binder resin, the content of the release agent is preferably 5 parts by mass or more, more preferably 10 parts by mass or more, and still more preferably 15 parts by mass or more, as the lower limit. On the other hand, the content of the release agent is preferably 30 parts by mass or less, and more preferably 25 parts by mass or less, as the upper limit.

When the content of the release agent is equal to or more than the lower limit value, the toner obtains excellent low-temperature fixability, and a decrease in image density is suppressed since the toner is likely to spread when fixed. When the content of the release agent is equal to or less than the upper limit value, the bleeding of the release agent is suppressed.

The content of the fatty acid ester compound in 100 parts by mass of the release agent is preferably 90 parts by mass or more, more preferably 95 parts by mass or more, and still more preferably 99 parts by mass or more.

### (Molecular Weight Modifier)

It is preferable that in the polymerization of the polymerizable monomer, a molecular weight modifier is used as another additive in the polymerizable monomer composition.

The molecular weight modifier is not particularly limited, as long as it is one that is generally used as a molecular weight modifier for toners. As the molecular weight modifier, examples include, but are not limited to, mercaptans such as t-dodecyl mercaptan, n-dodecyl mercaptan, n-octyl mercaptan and 2,2,4,6,6-pentamethylheptane-4-thiol; and thiuram disulfides such as tetramethyl thiuram disulfide, tetraethyl thiuram disulfide, tetrabutyl thiuram disulfide, N,N′-dimethyl-N,N′-diphenyl thiuram disulfide and N,N′-dioctadecyl-N,N′-diisopropyl thiuram disulfide. These molecular weight modifiers may be used alone or in combination of two or more thereof.

The content of the molecular weight modifier is generally from 0.01 parts by mass to 10 parts by mass, and preferably from 0.1 parts by mass to 5 parts by mass, with respect to 100 parts by mass of the monovinyl monomer.

### (A-2) Suspension Step (Droplet Forming Step) to Obtain Suspension

Then, the polymerizable monomer composition is dispersed in an aqueous medium containing a dispersion stabilizer, and after adding a polymerization initiator, droplet formation of the polymerizable monomer composition is performed. The polymerization initiator may be added before the droplet formation after the polymerizable monomer composition is dispersed in an aqueous medium, as described above. However, the polymerization initiator may be added to the polymerizable monomer composition before being dispersed in an aqueous medium.

As the polymerization initiator, examples include, but are not limited to, persulfates such as potassium persulfate and ammonium persulfate; azo compounds such as 4,4′-azobis(4-cyanovaleric acid), 2,2′-azobis(2-methyl-N-(2-hydroxyethyl)propionamide), 2,2′-azobis(2-amidinopropane)dihydrochloride, 2,2′-azobis(2,4-dimethylvaleronitrile) and 2,2′-azobisisobutyronitrile; and organic peroxides such as di-t-butylperoxide, benzoylperoxide, t-butylperoxy-2-ethylhexanoate, t-butylperoxy-2-ethylbutanoate, t-hexylperoxy-2-ethylbutanoate, t-butylperoxy diethylacetate, diisopropylperoxydicarbonate, di-t-butylperoxyisophthalate and t-butylperoxyisobutyrate. Among them, an organic peroxide is preferably used because the residual polymerizable monomer can be reduced, and the printing durability of the toner thus obtained becomes excellent. From the point of view that the initiator efficiency is high and the residual polymerizable monomer can be reduced, among the organic peroxides, peroxy esters are preferred, and non-aromatic peroxy esters, that is, peroxy esters containing no aromatic ring, are more preferred.

These polymerization initiators may be used alone or in combination of two or more thereof.

The amount of the polymerization initiator to be added, which is used for the polymerization of the polymerizable monomer composition, is preferably from 0.1 parts by mass to 20 parts by mass, more preferably from 0.3 parts by mass to 15 parts by mass, and still more preferably from 1 part by mass to 10 parts by mass, with respect to 100 parts by mass of the monovinyl monomer.

In the present disclosure, the aqueous medium is a medium containing water as a main component, and it is typically water.

In the present disclosure, it is preferable that a dispersion stabilizer is contained in the aqueous medium. As the dispersion stabilizer, examples include the following inorganic and organic compounds: inorganic compounds including sulfates such as barium sulfate and calcium sulfate, carbonates such as barium carbonate, calcium carbonate and magnesium carbonate, phosphates such as calcium phosphate, metal oxides such as aluminum oxide and titanium oxide, metal hydroxides such as aluminum hydroxide, magnesium hydroxide and iron(II) hydroxide, and organic compounds including water-soluble polymers such as polyvinyl alcohol, methyl cellulose and gelatin, anionic surfactants, nonionic surfactants, and ampholytic surfactants. These dispersion stabilizers may be used alone or in combination of two or more thereof.

Among the dispersion stabilizers, the inorganic compound, especially a colloid of the sparingly water-soluble metal hydroxide, is preferred. The use of the inorganic compounds, particularly the use of the colloid of the sparingly water-soluble metal hydroxide, can narrow the particle size distribution of the colored resin particles and can reduce the amount of the dispersion stabilizer remaining after washing. Accordingly, the toner thus obtained becomes capable of reproducing clear images and is excellent in environmental stability.

The sparingly water-soluble metal hydroxide colloid can be prepared by, for example, reacting a water-soluble polyvalent metal salt (excluding an alkaline earth metal hydroxide salt) and at least one selected from the group consisting of an alkali metal hydroxide salt and an alkaline earth metal hydroxide salt in the aqueous medium.

As the alkali metal hydroxide salt, examples include, but are not limited to, lithium hydroxide, sodium hydroxide and potassium hydroxide. As the alkaline earth metal hydroxide salt, examples include, but are not limited to, barium hydroxide and calcium hydroxide.

The water-soluble polyvalent metal salt may be a water-soluble polyvalent metal salt other than compounds corresponding to alkaline earth metal hydroxide salts. As the water-soluble polyvalent metal salt, examples include, but are not limited to, a magnesium metal salt such as magnesium chloride, magnesium phosphate and magnesium sulfate; a calcium metal salt such as calcium chloride, calcium nitrate, calcium acetate and calcium sulfate; an aluminum metal salt such as aluminum chloride and aluminum sulfate; a barium salt such as barium chloride, barium nitrate and barium acetate; and a zinc salt such as zinc chloride, zinc nitrate and zinc acetate. Among them, a magnesium metal salt, a calcium metal salt and an aluminum metal salt are preferred; a magnesium metal salt is more preferred; and magnesium chloride is particularly preferred.

The content of the dispersion stabilizer is appropriately adjusted so that the toner having the desired particle diameter is obtained, and it is not particularly limited. With respect to 100 parts by mass of the polymerizable monomer in the polymerizable monomer composition, the content of the dispersion stabilizer is preferably from 0.5 parts by mass to 10 parts by mass, and more preferably from 1.0 part by mass to 8.0 parts by mass. When the content of the dispersion stabilizer is equal to or more than the lower limit value, the droplets of the polymerizable monomer composition can be sufficiently dispersed in the suspension so that they do not join together. On the other hand, when the content of the dispersion stabilizer is equal to or less than the upper limit value, an increase in the viscosity of the suspension can be prevented during the droplet formation, and a failure such as clogging of a granulator with the suspension can be avoided.

Also, the content of the dispersion stabilizer is generally from 1 part by mass to 15 parts by mass, and preferably from 1 part by mass to 8 parts by mass, with respect to 100 parts by mass of the aqueous medium.

The polymerizable monomer composition is poured into the aqueous medium containing the dispersion stabilizer, and the mixture is strongly stirred, thereby obtaining a suspension in which the polymerizable monomer composition droplets are dispersed in the aqueous medium.

The strong stirring for forming the polymerizable monomer composition droplets, is not particularly limited. For example, it can be carried out by any of the following dispersers: a horizontal or vertical in-line disperser such as MILDER (product name, manufactured by Pacific Machinery & Engineering Co., Ltd.), CAVITRON (product name, manufactured by EUROTEC, Ltd.) and an in-line disperser manufactured by IKA (e.g., DISPAX-REACTOR (registered trademark) DRS (product name)), and an emulsifying disperser such as HOMOMIXER MARK II series manufactured by PRIMIX Corporation.

In the suspension step, the stirring time is appropriately adjusted depending on the amount of the polymerizable monomer composition, and it is not particularly limited.

### (A-3) Polymerization Step

After the polymerizable monomer composition is formed into droplets as described above in (A-2), the polymerizable monomer composition is subjected to a polymerization reaction in the presence of a polymerization initiator to form colored resin particles. In other words, a suspension in which droplets of the polymerizable monomer composition are dispersed, is heated to develop the polymerization reaction of the polymerizable monomer, thereby obtaining an aqueous dispersion of colored resin particles.

The heating temperature when the suspension is subjected to the polymerization reaction, is not particularly limited. From the viewpoint of quickly developing the polymerization reaction, the heating temperature is preferably 50° C. or more, and more preferably 60° C. or more. On the other hand, from the viewpoint of suppressing the rapid development of the polymerization reaction and stabilizing the quality of the obtained toner, the heating temperature is preferably 95° C. or less.

The polymerization reaction time is preferably from 1 hour to 20 hours, and more preferably from 2 hours to 15 hours.

Also in this polymerization step, following the above-described “(A-2) Suspension step (droplet forming step) to obtain suspension”, the polymerization reaction may be developed while continuing the dispersion treatment by stirring, in order to polymerize the droplets of the polymerizable monomer composition in a stably dispersed state.

In the present disclosure, the colorant resin particles obtained by the polymerization step, on which an external additive is added, may be used as the toner. It is preferable to use the colored resin particles obtained by the polymerization step as the core layer of colored resin particles of a so-called core-shell type (or also referred to as “capsule type”). The core-shell type colored resin particles have a structure in which the outside of the core layer is coated with a shell layer formed of a material different from the core layer. By coating the core layer made of a material having a low softening point with a material having a softening point higher than that, the low-temperature fixability and storage stability of the toner can be improved in a well-balanced manner.

The core-shell type colored resin particles are preferred because, since the shell suppresses the penetration of the external additive, toner deterioration caused by the penetration of the external additive is suppressed, resulting in the ease of keeping the toner charge amount during continuous printing and suppressing the occurrence of a print failure.

The method for producing the core-shell type colored resin particles by using the colored resin particles obtained by the polymerization step, is not particularly limited. The core-shell type colored resin particles can be produced by any conventional method. The in situ polymerization method and the phase separation method are preferable from the viewpoint of production efficiency.

A method for producing the core-shell type colored resin particles by the in situ polymerization method will be described below.

A polymerizable monomer for forming a shell layer (a polymerizable monomer for shell) and a polymerization initiator are added to the aqueous dispersion in which the colorant resin particles are dispersed, and the mixture is polymerized, thereby obtaining the core-shell type colored resin particles.

As the polymerizable monomer for shell, the same polymerizable monomers as the polymerizable monomers described above can be used. Among them, those that can be a polymer having a Tg of more than 80° C., such as styrene, acrylonitrile and methyl methacrylate, are preferably used alone or in combination of two or more thereof.

The amount of the polymerizable monomer for shell is not particularly limited. With respect to 100 parts by mass of the binder resin, the amount is preferably 1 part by mass or more, and more preferably 2 parts by mass or more, as the lower limit. On the other hand, the amount is preferably 5 parts by mass or less, and more preferably 4 parts by mass or less, as the upper limit. The mass of the binder resin is the same as the mass of the polymerizable monomer used in the core layer.

When the amount of the added polymerizable monomer for shell is equal to or more than the lower limit value, a decrease in the heat resistance of the toner is suppressed, and the occurrence of fogging is suppressed when the toner is used after long-time storage in a high-temperature and high-humidity environment. When the amount of the added polymerizable monomer for shell is equal to or less than the upper limit value, the toner is likely to spread when fixed, and a decrease in image density is suppressed, accordingly. When the amount of the added polymerizable monomer for shell is within the above range, the storage stability and low-temperature fixability of the toner is improved.

As the polymerization initiator used for the polymerization of the polymerizable monomer for shell, examples include, but are not limited to, water-soluble polymerization initiators including metal persulfates such as potassium persulfate and ammonium persulfate, and azo-type initiators such as 2,2′-azobis(2-methyl-N-(2-hydroxyethyl)propionamide) and 2,2′-azobis(2-methyl-N-(1,1-bis(hydroxymethyl)-2-hydroxyethyl)propionamide). These polymerization initiators may be used alone or in combination of two or more thereof.

The content of the polymerization initiator is preferably from 0.1 parts by mass to 30 parts by mass, and more preferably from 1 part by mass to 20 parts by mass, with respect to 100 parts by mass of the polymerizable monomer for shell.

The polymerization temperature of the shell layer is not particularly limited. From the viewpoint of quickly developing the polymerization reaction, the polymerization temperature of the shell layer is preferably 50° C. or more, and more preferably 60° C. or more. On the other hand, from the viewpoint of suppressing the volatilizing of the polymerizable monomer for shell, the polymerization temperature of the shell layer is preferably 95° C. or less.

The polymerization reaction time of the shell layer is preferably from 1 hour to 20 hours, and more preferably from 2 hours to 15 hours.

### (A-4) Washing, Filtrating, Dehydrating and Drying Step

It is preferable that, after completion of the polymerization, the operation of washing, filtration, dehydration and drying is repeatedly preformed several times as necessary on the aqueous dispersion of the colored resin particles obtained by the polymerization, according to a conventional method.

As the method of the washing, when an inorganic compound is used as the dispersion stabilizer, it is preferable to dissolve the dispersion stabilizer in water, by addition of an acid or an alkali to an aqueous dispersion of the colored resin particles, and then remove the dissolved dispersion stabilizer from the water. When a colloid of a hardly water-soluble inorganic hydroxide is used as the dispersion stabilizer, it is preferable to add an acid to adjust the pH of the colored resin particle aqueous dispersion to 6.5 or less. As the acid to be added, inorganic acids such as sulfuric acid, hydrochloric acid and nitric acid, and organic acids such as formic acid and acetic acid can be used, and sulfuric acid is particularly preferred because of the high removal efficiency and small burden on the production facilities.

The dehydration and filtration may be carried out by various known methods, without any particular limitation. For example, a centrifugal filtration method, a vacuum filtration method and a pressure filtration method may be used. Also, the drying method is not particularly limited, and various kinds of methods may be used.

### (B) Pulverization Method

In the case of producing the colored resin particles by using the pulverization method, the production is carried out by the following steps, for example.

First, a binder resin, a colorant, a positively-chargeable charge control resin, a polar resin, a release agent, and other additives which are added as needed, such as a styrene-based thermoplastic elastomer, are mixed by use of a mixer such as a ball mill, a V type mixer, FM MIXER (product name, manufactured by Nippon Coke & Engineering Co., Ltd.), a high-speed dissolver, an internal mixer and a fallberg. Next, the thus-obtained mixture is kneaded while heating by use of a press kneader, a twin screw kneading machine, a roller or the like. The thus-obtained kneaded product is coarsely pulverized by use of a pulverizer such as a hammer mill, a cutter mill and a roller mill. The coarsely pulverized product is finely pulverized by use of a pulverizer such as a jet mill and a high-speed rotary pulverizer. Then, the finely pulverized product is classified into desired particle diameters by use of a classifier such as an air classifier and an airflow classifier, thereby obtaining the colored resin particles produced by the pulverization method.

As the binder resin, colorant, positively-chargeable charge control resin, polar resin, release agent and styrene-based thermoplastic elastomer used in the pulverization method, those mentioned above in “(A) Suspension polymerization method” can be used. Besides the above-described binder resin, for example, a resin that has been widely used in toners can be used as the binder resin, such as a polystyrene, a polyester-based resin and an epoxy-based resin.

Also, the colored resin particles obtained by the pulverization method can be core-shell type colored resin particles by an in situ polymerization method or the like, in the same way as the colored resin particles obtained by the above-mentioned “(A) Suspension polymerization method”.

### 2. Colored Resin Particles

The colored resin particles are obtained by the production method such as the above-mentioned wet method (e.g., “(A) Suspension polymerization method”) and the above-mentioned dry method (e.g., “(B) Pulverization Method”).

Hereinafter, the colored resin particles contained in the toner will be described. The colored resin particles described below include both core-shell type colored resin particles and colored resin particles which are not core-shell type.

The volume average particle diameter (Dv) of the colored resin particles is not particularly limited. The Dv is preferably from 3 μm to 15 μm, and more preferably from 4 μm to 12 μm. When the Dv within the above range, a decrease in toner flowability, a deterioration in toner transferability, a decrease in image density, and a decrease in image resolution are less likely to occur.

The colored resin particles are preferably particles having a ratio (Dv/Dn) of the volume average particle diameter (Dv) to the number average particle diameter (Dn) of from 1.0 to 1.3, and more preferably from 1.0 to 1.2. When the Dv/Dn is within the above range, a deterioration in toner transferability, a decrease in image density and a decrease in image resolution are less likely to occur.

The volume average particle diameter and number average particle diameter of the colored resin particles can be measured by use of a particle size analyzer (product name: MULTISIZER; manufactured by Beckman Coulter, Inc.) or the like.

The average circularity of the colored resin particles is preferably from 0.96 to 1.00, more preferably from 0.97 to 1.00, and still more preferably from 0.98 to 1.00, from the viewpoint of image reproducibility.

When the average circularity of the colored resin particles is within the above range, fine line reproducibility of printing is improved.

### 3. Toner

The toner of the present disclosure can be obtained by an external addition treatment in which the external additive is mixed and stirred with the colored resin particles obtained by the above-described method. The toner of the present disclosure is such that the external additive is added on the surface of the colored resin particles, and the toner can be used as a one-component toner (developer). The one-component toner may be mixed and stirred with carrier particles to obtain a two-component developer.

As the method of the external addition treatment for adding the external additive on the surface of the colored resin particles, a known external addition treatment method can be employed and is not particularly limited. For example, the external addition treatment can be performed by mixing and stirring the colored resin particles and the external additive using a mixer which is capable of mixing and stirring, such as FM MIXER (product name, manufactured by Nippon Coke & Engineering Co., Ltd.), SUPER MIXER (product name, manufactured by KAWATA Manufacturing Co., Ltd.), Q MIXER (product name, manufactured by Nippon Coke & Engineering Co., Ltd.), MECHANOFUSION SYSTEM (product name, manufactured by Hosokawa Micron Corporation) and MECHANOMILL (product name, manufactured by Okada Seiko Co., Ltd.)

As the external additive, examples include, but are not limited to, inorganic fine particles such as fine particles of silica, titanium oxide, aluminum oxide, zinc oxide, tin oxide, strontium titanate, calcium carbonate, calcium phosphate and cerium oxide; organic fine particles such as fine particles of polymethyl methacrylate resin, silicone resin and melamine resin; and fine particles of metallic soap such as fine particles of zinc stearate and magnesium stearate. Among them, inorganic fine particles are preferred. Among inorganic fine particles, silica fine particles and titanium oxide fine particles are preferred, and silica fine particles are particularly preferred. These external additives may be used alone, and they are preferably used in combination of two or more kinds.

As the external additive, inorganic fine particles A having a number average primary particle diameter of from 5 nm to 14 nm and inorganic fine particles B having a number average primary particle diameter of from 15 nm to 90 nm are preferably contained.

When the inorganic fine particles A and B are contained as the external additive, the mass ratio of the inorganic fine particles A to the inorganic fine particles B (the inorganic fine particles A: the inorganic fine particles B) is not particularly limited, and it may be from 20:80 to 80:20, for example.

The number average primary particle diameter of the external additive particles is measured as follows, for example. First, about 0.1 g of a measurement sample is weighed out and put in a beaker. Next, as a dispersant, 0.1 mL of an alkylbenzene sulfonic acid aqueous solution (product name: DRIWEL, manufactured by Fujifilm Corporation) is added thereto. In addition, 10 mL to 30 mL of a diluent (product name: ISOTON II, manufactured by Beckman Coulter, Inc.) is put in the beaker. The mixture is dispersed for 3 minutes with a 20 W (watt) ultrasonic disperser. Then, the number average primary particle diameter is measured with a particle size analyzer (product name: MULTISIZER, manufactured by Beckman Coulter, Inc.) under the following condition: aperture diameter: 100 μm, medium: ISOTON II, and the number of measured particles: 100,000 particles.

The content of the external additive is not particularly limited. It is preferably from 0.05 parts by mass to 6 parts by mass, and more preferably from 0.2 parts by mass to 5 parts by mass, with respect to 100 parts by mass of the colored resin particles. When the content of the external additive is within the above range, a transfer residue and fogging are likely to be suppressed.

The toner of the present disclosure is a toner in which the release agent is less likely to bleed out even in a high-temperature and high-humidity environment. Accordingly, the bleeding rate of the toner of the present disclosure after stored for 30 days in a high-temperature and high-humidity environment at a temperature of 47° C. and a humidity of 80% RH can be less than 15%. The bleeding rate is calculated as the percentage of the number (B) of the toner particles from which the release agent bleeds out, with respect to the number (A) of all the toner particles. In a more preferred embodiment, the bleeding rate can be less than 10%. In a still more preferred embodiment, the bleeding rate can be less than 5%. More specifically, the bleeding rate of the toner can be obtained by the same method as a bleeding rate evaluation described below in “Examples”.

In the case of using the toner of the present disclosure, in both a low-temperature and low-humidity environment and a high-temperature and high-humidity environment, by use of a toner cartridge filled with a large amount of the toner, continuous printing can be carried out while suppressing a print failure, until the amount of the remaining toner is low.

Accordingly, when a printing durability test is carried out in a high-temperature and high-humidity environment using the toner of the present disclosure, the number of continuously printed sheets that can keep an image quality with a fog value of 2.0 or less, can be 10000 or more. In a more preferred embodiment, it can be 15000 or more. In a still more preferred embodiment, it can be more than 20000.

In addition, when a printing durability test is carried out in a high-temperature and high-humidity environment using a toner cartridge filled with 500 g of the toner of the present disclosure, the toner amount that can keep an image quality with a fog value of 2.0 or less, can be such an amount, that the percentage of the remaining toner in the cartridge is 60% or less. In a more preferred embodiment, the toner amount can be such an amount, that the percentage of the remaining toner in the cartridge is 50% or less. In a still more preferred embodiment, the toner amount can be such an amount, that the percentage of the remaining toner in the cartridge is 40% or less.

The percentage of the remaining toner can be obtained by the following formula, using a cartridge weight X (g) after the continuous printing and a cartridge weight Y (g) before the cartridge is filled with the toner.

Percentage of remaining toner (%)={(X−Y)/Y}×100

The printing durability test in a high-temperature and high-humidity environment and the specification of the fog value can be carried out in the same manner as a HH durability test which will be described below in “Examples”.

Also, when a printing durability test is carried out in a low-temperature and low-humidity environment using the toner of the present disclosure, the number of continuously printed sheets that can keep an image quality with an image density (reflection density) of 1.3 or more, can be 10000 or more. In a more preferred embodiment, it can be 15000 or more. In a still more preferred embodiment, it can be more than 20000.

In addition, when a printing durability test is carried out in a low-temperature and low-humidity environment using a toner cartridge filled with 500 g of the toner of the present disclosure, the toner amount that can keep an image quality with an image density of 1.3 or more, can be such an amount, that the percentage of the remaining toner in the cartridge is 60% or less. In a more preferred embodiment, the toner amount can be such an amount, that the percentage of the remaining toner in the cartridge is 50% or less. In a still more preferred embodiment, the toner amount can be such an amount, that the percentage of the remaining toner in the cartridge is 40% or less.

The printing durability test in a low-temperature and low-humidity environment and the specification of the image density can be carried out in the same manner as a LL durability test described below in “Examples”.

The toner of the present disclosure is less likely to cause a print failure even when the toner is used after long-time storage in a high-temperature and high-humidity environment. Accordingly, when a printing durability test is carried out in a high-temperature and high-humidity environment using the toner of the present disclosure after the toner is stored for 30 days in a high-temperature and high-humidity environment at a temperature of 47° C. and a humidity of 80% RH, the number of continuously printed sheets that can keep an image quality with a fog value of 2.0 or less, can be 10000 or more. In a more preferred embodiment, it can be 15000 or more. In a still more preferred embodiment, it can be more than 20000.

The toner of the present disclosure is a toner such that a fluctuation in the charge amount of the toner, which is involved in temperature and humidity changes, is suppressed. Accordingly, the difference (Q1−Q2) between a toner charge amount Q1 (μC/g), which is a charge amount at the time when continuous printing is carried out on up to 100 sheets in a low-temperature and low-humidity environment using the toner of the present disclosure, and a toner charge amount Q2 (μC/g), which is a charge amount at the time when continuous printing is carried out on up to 100 sheets in a high-temperature and high-humidity environment using the toner of the present disclosure, can be less than 25 μC/g. In a more preferred embodiment, the difference can be less than 20 μC/g. In a still more preferred embodiment, the difference can be less than 15 μC/g. The continuous printing in a low-temperature and low-humidity or high-temperature and high-humidity environment and the specification of the toner charge amounts Q1 and Q2 can be carried out in the same manner as “Charge fluctuation due to environment” described below in “Examples”.

### 4. Image Forming Method

The toner of the present disclosure is a toner such that when a toner cartridge filled with a large amount of the toner is used, in both a low-temperature and low-humidity environment and a high-temperature and high-humidity environment, continuous printing can be carried out while suppressing a print failure, until the amount of the remaining toner is low. Accordingly, in the image forming method using the toner of the present disclosure, the effects of the toner of the present disclosure are effectively exerted when a toner cartridge filled with a large amount of the toner is used.

In the image forming method of the present disclosure, the amount of the toner filled into the cartridge is preferably 300 g or more, more preferably 400 g or more, and still more preferably 500 g or more. The amount of the toner filled into the cartridge is generally 1000 g or less.

Also in the image forming method of the present disclosure, the amount of the toner used, which does not cause an impractical level of print failure, can be such an amount that the percentage of the toner remaining in the cartridge is 60% or less. In a more preferred embodiment, it can be such an amount that the percentage of the toner remaining in the cartridge is 50% or less. In a still more preferred embodiment, it can be such an amount that the percentage of the toner remaining in the cartridge is 40% or less.

The image forming method using the toner of the present disclosure is a general image forming method, and it is not particularly limited except for the above-described amount of the toner filled into the cartridge and the above-described percentage of the remaining toner. As the image forming method, examples include, but are not limited to, an image forming method comprising a charging step, an exposure step, a developing step, a transfer step, a cleaning step and a fixing step.

The charging step includes positively or negatively charging the surface of the photoconductor uniformly, by use of a charge member. As the charging method by use of the charge member, examples include, but are not limited to, a contact charging method with use of a charge roll, a fur brush, a magnetic brush, a blade or the like, and a non-contact charging method by corona discharge.

The exposure step includes irradiating the surface of the photoconductor with a light corresponding to an image signal by an exposure device to form an electrostatic latent image on the surface of the uniformly charged photoconductor. As the exposure device, examples include, but are not limited to, a laser irradiation device and a LED irradiation device.

The developing step includes attaching the toner to the electrostatic latent image, which is formed on the surface of the photoconductor by the exposure step, to form a visible image by a development device. In the case of reversal development, the toner is attached only to an irradiated part. In the case of normal development, the toner is attached only to an unirradiated part.

The transfer step includes transferring the visible image formed on the surface of the photoconductor by the developing device to a recording medium such as paper. In general, the visible image is transferred by a transfer roller. As another transfer method, examples include, but are not limited to, belt transfer and corona transfer.

The cleaning step includes cleaning the toner remaining on the surface of the photoconductor after the transfer step. For example, the cleaning step is carried out by pressing a cleaning blade against the photoconductor to scrape off the remaining toner from the surface of the photoconductor. The removed toner is generally recovered by a recovery device.

The fixing step includes fixing the visible image of the toner, which is transferred to the recording medium. For example, the fixing step is carried out by rotating at least one of a heating roller, which is heated by a heating device, or a support roller to pass and hot-press the recording medium through the rollers.

Known fixing methods include heating, pressing, hot-pressing, solvent fume and so on. Of them, the hot-pressing method by use of the heating roller as described above, is most commonly used.

### EXAMPLES

Hereinafter, the present disclosure will be described further in detail, with reference to Examples and Comparative Examples. However, the present disclosure is not limited to these examples. Herein, part(s) and % are on a mass basis unless otherwise noted.

### Production Example 1: Synthesis of Polar Resin P1

First, 200 parts of toluene was put in a reaction container. While stirring the toluene, the gas inside the reaction container was sufficiently replaced with nitrogen. Then, the temperature of the toluene was raised to 90° C. Then, a mixed solution of 97.0 parts of methyl methacrylate, 2.6 parts of ethyl acrylate, 0.4 parts of acrylic acid, and 3 parts of t-butylperoxy-2-ethylhexanoate (product name: PERBUTYL O, manufactured by NOF Corporation) was added dropwise to the reaction container for two hours. Also, the condition of the mixture was maintained for 10 hours under toluene flux, thereby completing polymerization. Then, the solvent was removed by distillation under reduced pressure, thereby obtaining a polar resin P1 (MMA/EA/AA). The polar resin P1 had an acid value of 2.5 mgKOH/g, a Tg of 74° C., and a Mw of 12600.

### Production Example 2: Synthesis of Polar Resin P2

A polar resin P2 (MMA/EA/AA) was obtained in the same manner as Production Example 1, except that 97.3 parts of methyl methacrylate, 2.6 parts of ethyl acrylate, and 0.1 parts of acrylic acid were used. The obtained polar resin P2 had an acid value of 0.5 mgKOH/g, a Tg of 74° C., and a Mw of 12500.

### Production Example 3: Synthesis of Polar Resin P3

A polar resin P3 (MMA/EA/AA) was obtained in the same manner as Production Example 1, except that 96.6 parts of methyl methacrylate, 2.6 parts of ethyl acrylate, and 0.8 parts of acrylic acid were used. The obtained polar resin P3 had an acid value of 5.0 mgKOH/g, a Tg of 74° C., and a Mw of 12300.

### Production Example 4: Synthesis of Polar Resin P4

A polar resin P4 (MMA/EA/AA) was obtained in the same manner as Production Example 1, except that 95.9 parts of methyl methacrylate, 2.5 parts of ethyl acrylate, and 1.6 parts of acrylic acid were used. The obtained polar resin P4 had an acid value of 10.0 mgKOH/g, a Tg of 74° C., and a Mw of 12700.

### Production Example 5: Synthesis of SIS Composition

First, 23.2 kg of cyclohexane, 1.5 mmol of N,N,N′,N′-tetramethylethylenediamine (TMEDA) and 1.70 kg of styrene were put in a pressure-resistant reactor and stirred at 40° C. While stirring them at 40° C., 99.1 mmol of n-butyllithium was added thereto. With increasing the temperature of the obtained mixture to 50° C., the mixture was polymerized for one hour. The polymerization conversion rate of the styrene was 100% by mass. With controlling the temperature of the mixture at 50° C. to 60° C., 6.03 kg of isoprene was continuously added to the reactor for one hour. After the addition of the isoprene was completed, the mixture was further polymerized for one hour, thereby obtaining a styrene-isoprene diblock copolymer (a) (a copolymer (a) represented by Ar-D). The polymerization conversion rate of the isoprene was 100% by mass. Next, 15.0 mmol of dimethyldichlorosilane was added thereto as a coupling agent to initiate a coupling reaction, and the coupling reaction was continued for two hours, thereby forming a styrene-isoprene-styrene triblock copolymer (b) (a copolymer (b) represented by Ar-D-Ar). Then, 198 mmol of methanol was added thereto as a polymerization inhibitor, and they were mixed well to stop the reaction, thereby obtaining a reaction solution containing a styrene-isoprene-styrene triblock copolymer (SIS) composition containing the block copolymers (a) and (b). Part of the obtained reaction solution was removed and used to measure the following: the weight average molecular weight Mw of each block, the weight average molecular weight Mw of each block copolymer, the weight average molecular weight Mw of the whole SIS composition, the content rate of each block copolymer, the content of the styrene unit, and the content of the vinyl bond in the conjugated diene block. The results are shown in Table 1.

Then, to 100 parts of the thus-obtained reaction solution (containing 30 parts of a polymer component), 0.3 parts of 2,6-di-tert-butyl-p-cresol was added as an antioxidant. They were mixed to obtain a mixed solution, and the mixed solution was gradually added in a dropwise manner to a hot water at 85° C. to 95° C. to vaporize the solvent, thereby obtaining precipitates. The precipitates were pulverized and dried by hot air at 85° C., thereby recovering the SIS composition. The melt index of the obtained SIS composition was measured. The result is shown in Table 1. In Tables 3 to 5, the SIS composition is simply expressed as “SIS”.

### Production Example 6: Synthesis of SBS Composition

A styrene-1,3-butadiene-styrene triblock copolymer (SBS) composition was obtained in the same manner as Production Example 5, except that the styrene amount was changed to 2.32 kg, and 5.41 kg of butadiene was used instead of 6.03 kg of isoprene. In Tables 3 to 5, the SBS composition is simply expressed as “SBS”.

TABLE 1

| | | SIS | SBS |
|---|---|---|---|
| | | composition | composition |
| Diblock | Mw of diblock copolymer (a) | 109000 | 91000 |
| copolymer (a) | Mw of styrene block | 17000 | 15000 |
| | Mw of conjugated diene block | 92000 | 76000 |
| Triblock | Mw of triblock copolymer (b) | 218000 | 182000 |
| copolymer (b) | Mw of styrene block | 17000 | 15000 |
| | Mw of conjugated diene block | 184000 | 152000 |
| Whole | Mw of whole composition | 142000 | 127000 |
| composition | Styrene unit content (%) | 22 | 30 |
| | Vinyl bond content (mol %) in conjugated diene block | 7 | 10 |
| | Content rate (%) of diblock copolymer (a) | 70 | 60 |
| | Content rate (%) of triblock copolymer (b) | 30 | 40 |
| | Melt index (g/10 min) G condition | 10 | 22 |

### Example 1

### 1. Production of Colored Resin Particles

First, the following materials were mixed and wet-pulverized by use of a media type emulsifying disperser: 70 parts of styrene and 30 parts of n-butyl acrylate as a monovinyl monomer; 9 parts of carbon black (product name: #25B, manufactured by Mitsubishi Chemical Corporation) as a black colorant; 0.7 parts of divinylbenzene as a crosslinkable polymerizable monomer; 1.0 part of t-dodecyl mercaptan as a molecular weight modifier; and 1.00 part of the polar resin P1 as a polar resin, which was obtained in the Production Example 1. Then, the following materials were further added thereto and mixed: 1.5 parts of CCR-A1 (the copolymerization ratio of the quaternary ammonium salt group-containing monomer: 2.00%) as the copolymer A (a positively-chargeable charge control resin), 1.0 part of CCR-B1 (the copolymerization ratio of the quaternary ammonium salt group-containing monomer: 1.00%) as the copolymer B (a positively-chargeable charge control resin), 20 parts of behenyl stearate (molecular formula: C₁₇H₃₅—COO—C₂₂H₄₅, melting point: 70° C., acid value: 0.1 mgKOH/g, hydroxyl value: 0.3 mgKOH/g, esterification rate: 98%) as the release agent, and 5.0 parts of the SIS composition (obtained in Production Example 5) as the styrene-based thermoplastic elastomer. Thus, a polymerizable monomer composition was obtained.

The monomer units constituting CCR-A1 and CCR-B1 and the copolymerization ratios thereof (% by mass) are as shown in Table 2.

Meanwhile, in a stirring tank, at room temperature, an aqueous solution in which 4.1 parts of sodium hydroxide was dissolved in 50 parts of deionized water, was gradually added under stirring to an aqueous solution in which 7.4 parts of magnesium chloride was dissolved in 250 parts of deionized water, thereby preparing a magnesium hydroxide colloidal dispersion (magnesium hydroxide: 3.0 parts).

At room temperature, the polymerizable monomer composition was added to the magnesium hydroxide colloidal dispersion obtained above, and the mixture was stirred until the droplets were stabilized. As a polymerization initiator, 5 parts of t-butylperoxy-2-ethylhexanoate (product name: PERBUTYL O, manufactured by NOF Corporation) was added thereto. Then, the thus-obtained mixture was subjected to high-speed shearing at a rotational frequency of 15,000 rpm by use of an in-line type emulsifying disperser (product name: MILDER, manufactured by Pacific Machinery & Engineering Co., Ltd.) to form the droplets of the polymerizable monomer composition.

The thus-obtained suspension in which the droplets of the polymerizable monomer composition were dispersed (a polymerizable monomer composition dispersion) was put in a reactor furnished with stirring blades, and the temperature thereof was increased to 90° C. to initiate a polymerization reaction. When the polymerization conversion rate reached almost 100%, 3.0 parts of methyl methacrylate as a polymerizable monomer for shell was added to the reactor. The reaction was further continued for 3 hours at 90° C. Then, the reaction was stopped by water-cooling the reactor, thereby obtaining an aqueous dispersion of colored resin particles.

While stirring the aqueous dispersion of the colored resin particles obtained above, the aqueous dispersion was subjected to acid washing by adding sulfuric acid in a dropwise manner at room temperature, until the pH of the aqueous dispersion reached 6.5 or less. Next, the aqueous dispersion was subjected to filtration separation. Then, a solid matter thus obtained was mixed with 500 parts of deionized water, re-slurried, repeatedly subjected to a water washing treatment (washing, filtering and dehydrating) several times, and then subjected to filtration separation. A solid matter thus obtained was put in the container of a dryer and dried at 45° C. for 48 hours, thereby obtaining dried colored resin particles.

To 100 parts of the colored resin particles, the following particles were added as the external additive.

Silica fine particles A having a number average primary particle diameter 10 nm: 0.7 parts

Silica fine particles B having a number average primary particle diameter of 55 nm (particles hydrophobized with amino-modified silicone oil): 1 part

External addition treatment was performed by mixing the particles by use of a high-speed stirring machine (product name: FM MIXER, manufactured by Nippon Coke & Engineering Co., Ltd.), thereby preparing the toner of Example 1.

### Examples 2 to 21 and Comparative Examples 1 to 8

The toners of Examples 2 to 21 and Comparative Examples 1 to 8 were obtained in the same manner as Example 1, except that the materials added to the polymerizable monomer composition were changed according to Tables 3 to 5.

The monomer units constituting the copolymers A, B and C used in Examples and Comparative Examples and the copolymerization ratios thereof (% by mass) are shown in Table 2.

TABLE 2

| | | | N,N-diethyl-N-methyl-2- |
|---|---|---|---|
| | | Butyl | (methacryloyloxy)ethyl ammonium |
| | Styrene | acrylate | p-toluenesulfonate |
| | (%) | (%) | (%) |
| CCR-A1 | 82.0 | 16.0 | 2.00 |
| CCR-A2 | 82.0 | 16.5 | 1.50 |
| CCR-A3 | 80.0 | 14.0 | 6.00 |
| CCR-B1 | 82.0 | 17.0 | 1.00 |
| CCR-B2 | 85.0 | 14.9 | 0.10 |
| CCR-B3 | 82.0 | 16.7 | 1.30 |
| CCR-B4 | 82.0 | 16.8 | 1.20 |
| CCR-B5 | 82.0 | 16.6 | 1.40 |
| CCR-C1 | 75.0 | 15.0 | 10.00 |
| CCR-C2 | 85.0 | 15.0 | 0.00 |

### [Evaluation]

The toners of the Examples and the Comparative Examples and the colored resin particles used in these toners were evaluated. The details are as follows.

### (1) Evaluation of Colored Resin Particles

a. Volume Average Particle Diameter (Dv), Number Average Particle Diameter (Dn), and Particle Size Distribution (Dv/Dn)

About 0.1 g of the colored resin particles were weighed out and put in a beaker. Next, as a dispersant, 0.1 mL of a surfactant aqueous solution (product name: DRIWEL, manufactured by Fujifilm Corporation) was added thereto. In addition, 10 mL to 30 mL of ISOTON II was put in the beaker. The mixture was dispersed for 3 minutes with a 20 W (watt) ultrasonic disperser. Then, the volume average particle diameter (Dv) and number average particle diameter (Dn) of the colored resin particles were measured with a particle size analyzer (product name: MULTISIZER, manufactured by Beckman Coulter, Inc.) in the following condition: aperture diameter: 100 μm, medium: ISOTON II, and the number of measured particles: 100,000 particles. Then, the particle size distribution (Dv/Dn) of the colored resin particles was calculated.

b. Average Circularity

First, 10 mL of deionized water was put in a container; as a dispersant, 0.02 g of a surfactant was added thereto; and 0.02 g of the colored resin particles was further added thereto and dispersed for three minutes at 60 W by using an ultrasonic disperser. The concentration of the colored resin particles at the time of the measurement was adjusted to be from 3000 particles/μL to 10,000 particles/μL. Using a flow type particle image analyzer (product name: FPIA-3000, manufactured by Sysmex Corporation), the circularity was measured for 5,000 to 10,000 colored resin particles having an equivalent circle diameter of 0.4 μm or more. From the measured values, the average circularity was obtained. The circularity is represented by the following calculation formula 1, and the average circularity is the number average thereof.

$$Circularity = ( Perimeter of a circle having the same area \\ as the projected area of a particle image ) / \\ ( Perimeter of the projected particle image ) \qquad Calculation formula 1$$

### (2) Toner Evaluation

a. Bleeding Rate

First, the toner was stored for 30 days in an environment at a temperature of 47° C. and a humidity of 80% RH to prepare a toner after storage.

The toner after storage was observed by SEM. Ten images of the toner were taken at a magnification of 2,000 times. Next, for each toner image, the number (A) of all toner particles in the image and the number (B) of toner particles on which the bled release agent was attached in the image, were counted. The toner particles on which the bled release agent was attached, were defined as toner particles such that the release agent having a maximum length of more than 0.3 μm was found attached thereon. Then, for each toner image, the number (B) of the toner particles was divided by the number (A) of the toner particles, and the resulting value was multiplied by 100 to calculate a value. The average of the values calculated for the ten toner images was defined as the bleeding rate (%) of the toner. Based on the bleeding rate, the bleed suppressing effect was evaluated according to the following evaluation criteria.

### (Evaluation Criteria)

A: The bleeding rate was less than 5%.
B: The bleeding rate was 5% or more and less than 10%.
C: The bleeding rate was 10% or more and less than 15%.
D: The bleeding rate was 15% or more.
   b. Printing Durability Test in High-Temperature and High-Humidity Environment (HH Durability Test)

In the printing durability test, a commercially-available, non-magnetic one-component development printer (printing speed: 40 A4-size sheets/min) was used. The printing durability test in a high-temperature and high-humidity environment was carried out by the following steps.

First, 500 g of the toner was filled into the toner cartridge of the development device. The printer was left for 24 hours in a high-temperature and high-humidity environment at a temperature of 33.5° C. and a humidity of 82% RH. In the same environment, 20,000 sheets were continuously printed at a coverage rate of 5%. At every 500th sheets, solid pattern printing (coverage rate 100%) was carried out on 5 sheets, followed by white solid pattern printing (coverage rate 0%), and the printer was stopped when the white solid pattern printing was in progress. Then, a piece of an adhesive tape (product name: SCOTCH MENDING TAPE 810-3-18, manufactured by Sumitomo 3M Limited) was attached to a non-image area on the photoconductor of the printer after development to make the toner in the area adhere to the tape piece. Then, the tape piece was attached to a printing sheet. Next, the whiteness degree (B) of the printing sheet on which the tape piece was attached, was measured with a whiteness colorimeter (manufactured by Nippon Denshoku Industries Co., Ltd.) In the same manner, an unused piece of the adhesive tape was attached to the printing sheet, and the whiteness degree (A) was measured. The difference in whiteness degree (B−A) was determined as a fog value. As the fog value decreases, fogging decreases and a better result is obtained.

The number of continuously printed sheets that were able to keep an image quality with a fog value of 2.0 or less, was measured. Based on the number of the continuously printed sheets thus measured, the printing durability in the high-temperature and high-humidity environment was evaluated according to the following evaluation criteria.

### (Evaluation Criteria)

A: More than 20000 Sheets
B: 15000 Sheets or more and 20000 sheets or less
C: 10000 Sheets or more and less than 15000 sheets
D: Less than 10000 sheets

The percentage of the remaining toner was obtained by the following formula, using a cartridge weight X (g) at the time when an image quality with a fog value of 2.0 or less was not able to be kept, and a cartridge weight Y (g) before the cartridge was filled with the toner.

$$Percentage of remaining toner ( \% ) = \{ ( X - Y ) / Y ) \times 100$$

c. Printing Durability Test in Low-Temperature and Low-Humidity Environment (LL Durability Test)

Using the same printer as the HH durability test, the printing durability test in a low-temperature and low-humidity environment was carried out by the following steps.

First, 500 g of the toner was filled into the toner cartridge of the development device. The printer was left for 24 hours in a low-temperature and low-humidity environment at a temperature of 10° C. and a humidity of 20% RH. Under the same environment, 20,000 sheets were continuously printed at a coverage rate of 5%. At every 500th sheets, solid pattern printing (coverage rate 100%) was carried out on 5 sheets. The image density (reflection density) of the printed solid image was measured by use of a reflection image densitometer (product name: RD918, manufactured by Macbeth).

The number of continuously printed sheets that were able to keep an image quality with an image density of 1.3 or more, was measured. Based on the number of the continuously printed sheets thus measured, the printing durability in the low-temperature and low-humidity environment was evaluated according to the following evaluation criteria.

### (Evaluation Criteria)

A: More than 20000 Sheets
B: 15000 Sheets or more and 20000 sheets or less
C: 10000 Sheets or more and less than 15000 sheets
D: Less than 10000 sheets

The percentage of the remaining toner was obtained in the same manner as described above, using a cartridge weight X (g) at the time when an image quality with an image density of 1.3 or more was not able to be kept, and a cartridge weight Y (g) before the cartridge was filled with the toner.

d. Printing Durability Test in High-Temperature and High-Humidity Environment for Toner after Storage in High-Temperature and High-Humidity Environment (HH Durability Test after Storage at High Temperature)

First, the toner was stored for 30 days in an environment at a temperature of 47° C. and a humidity of 80% RH to prepare a toner after storage in a high-temperature and high-humidity environment. Using the toner after storage, a printing durability test was carried out in the same manner as the HH durability test described above, and the number of continuously printed sheets that were able to keep an image quality with a fog value of 2.0 or less, was measured. Based on the number of the continuously printed sheets thus measured, for the toner after storage in the high-temperature and high-humidity environment, the printing durability in the high-temperature and high-humidity environment was evaluated according to the following evaluation criteria.

### (Evaluation Criteria)

A: More than 20000 Sheets
B: 15000 Sheets or more and 20000 sheets or less
C: 10000 Sheets or more and less than 15000 sheets
D: Less than 10000 sheets
   e. Charge Fluctuation Due to Environment

Using the same printer as the HH durability test, the toner was filled into the toner cartridge of the development device. The printer was left for 24 hours in a low-temperature and low-humidity environment at a temperature of 10° C. and a humidity of 20% RH. In the same environment, up to 100 sheets were continuously printed at a coverage rate of 5%. After printing 100 sheets, for the toner loaded on the developing roller, using a suction type charge amount measuring device, the charge amount and the suctioned toner amount were measured. The charge amount was divided by the suctioned toner amount, and the value thus obtained was determined as a toner charge amount Q1 (μC/g).

In the same manner as above, a toner charge amount Q2 (μC/g) was measured in a high-temperature and high-humidity environment at a temperature of 33.5° C. and a humidity of 82% RH.

As the index of the charge fluctuation due to the environment, the difference between Q1 and Q2 (Q1−Q2) was calculated. Based on the value thus obtained (Q1−Q2), the charge fluctuation due to the environment was evaluated according to the following evaluation criteria. The smaller the difference between Q1 and Q2, the smaller the fluctuation in the charge amount of the toner, which was involved in temperature and humidity changes.

### (Evaluation Criteria)

A: The difference (Q1−Q2) was less than 15 μC/g.
B: The difference (Q1−Q2) was 15 μC/g or more and less than 20 μC/g.
C: The difference (Q1−Q2) was 20 μC/g or more and less than 25 μC/g.
D: The difference (Q1−Q2) was 25 μC/g or more.

TABLE 3

| | | | Example 1 | Example 2 | Example 3 | Example 4 | Example 5 |
|---|---|---|---|---|---|---|---|
| Colored | Copolymer A | Type | CCR-A1 | CCR-A1 | CCR-A1 | CCR-A1 | CCR-A1 |
| resin | | Functional | 2.00 | 2.00 | 2.00 | 2.00 | 2.00 |
| particles | | group amount | | | | | |
| | | F_{A} (%) | | | | | |
| | | Amount m_{A} | 1.50 | 0.50 | 2.50 | 1.50 | 1.50 |
| | | (parts) | | | | | |
| | Copolymer B | Type | CCR-B1 | CCR-B1 | CCR-B1 | CCR-B1 | CCR-B1 |
| | | Functional | 1.00 | 1.00 | 1.00 | 1.00 | 1.00 |
| | | group amount | | | | | |
| | | F_{B} (%) | | | | | |
| | | Amount m_{B} | 1.00 | 1.00 | 1.00 | 0.75 | 1.00 |
| | | (parts) | | | | | |
| | F_{A} − F_{B} | | 1.00 | 1.00 | 1.00 | 1.00 | 1.00 |
| | F_{A} × m_{A} + F_{B} × m_{B} | | 4.00 | 2.00 | 6.00 | 3.75 | 4.00 |
| | Polar resin | Type | P1 | P1 | P1 | P1 | P1 |
| | | Acid value X | 2.5 | 2.5 | 2.5 | 2.5 | 2.5 |
| | | (mgKOH/g) | | | | | |
| | | Mw | 12600 | 12600 | 12600 | 12600 | 12600 |
| | | Tg (° C.) | 74 | 74 | 74 | 74 | 74 |
| | | Amount m_{P} | 1.00 | 1.00 | 1.00 | 1.00 | 0.50 |
| | | (parts) | | | | | |
| | \|X × m_{P} − F_{A} × m_{A}\| | | 0.50 | 1.50 | 2.50 | 0.50 | 1.75 |
| | Release agent | Type | Behenyl | Behenyl | Behenyl | Behenyl | Behenyl |
| | | | stearate | stearate | stearate | stearate | stearate |
| | | Mn | 592 | 592 | 592 | 592 | 592 |
| | | Amount | 20 | 20 | 20 | 20 | 20 |
| | | (parts) | | | | | |
| | Styrene-based | Type | SIS | SIS | SIS | SIS | SIS |
| | thermoplastic | Amount | 5.0 | 5.0 | 5.0 | 5.0 | 5.0 |
| | elastomer | (parts) | | | | | |
| | MMA for shell | Amount | 3.00 | 3.00 | 3.00 | 3.00 | 3.00 |
| | | (parts) | | | | | |

| | | | | | | |
|---|---|---|---|---|---|---|
| | Dv (μm) | 7.7 | 7.6 | 7.8 | 7.7 | 7.8 |
| | Dv/Dn | 1.10 | 1.10 | 1.10 | 1.10 | 1.11 |
| | Average circularity | 0.98 | 0.98 | 0.98 | 0.98 | 0.98 |
| Toner | Bleeding rate | A | A | A | B | B |
| evaluation | HH durability test | A | B | A | A | A |
| | Percentage of remaining | 24 | 35 | 28 | 28 | 33 |
| | toner (%) in HH durability test | | | | | |
| | LL durability test | A | A | B | A | A |
| | Percentage of remaining | 25 | 28 | 35 | 29 | 31 |
| | toner (%) in LL durability test | | | | | |
| | HH durability test after | A | B | B | B | B |
| | storage at high temperature | | | | | |
| | Charge fluctuation due to | A | A | A | A | A |
| | environment | | | | | |

| | | | Example 6 | Example 7 | Example 8 | Example 9 |
|---|---|---|---|---|---|---|
| Colored | Copolymer A | Type | CCR-A2 | CCR-A3 | CCR-A1 | CCR-A1 |
| resin | | Functional | 1.50 | 6.00 | 2.00 | 2.00 |
| particles | | group amount | | | | |
| | | F_{A} (%) | | | | |
| | | Amount m_{A} | 1.50 | 1.50 | 1.50 | 1.50 |
| | | (parts) | | | | |
| | Copolymer B | Type | CCR-B1 | CCR-B1 | CCR-B2 | CCR-B3 |
| | | Functional | 1.00 | 1.00 | 0.10 | 1.30 |
| | | group amount | | | | |
| | | F_{B} (%) | | | | |
| | | Amount m_{B} | 1.00 | 1.00 | 1.00 | 1.00 |
| | | (parts) | | | | |
| | F_{A} − F_{B} | | 0.50 | 5.00 | 1.90 | 0.70 |
| | F_{A} × m_{A} + F_{B} × m_{B} | | 4.00 | 4.00 | 4.00 | 4.00 |
| | Polar resin | Type | P1 | P1 | P1 | P1 |
| | | Acid value X | 2.5 | 2.5 | 2.5 | 2.5 |
| | | (mgKOH/g) | | | | |
| | | Mw | 12600 | 12600 | 12600 | 12600 |
| | | Tg (° C.) | 74 | 74 | 74 | 74 |
| | | Amount m_{P} | 1.00 | 1.00 | 1.00 | 1.00 |
| | | (parts) | | | | |
| | \|X × m_{P} − F_{A} × m_{A}\| | | 0.50 | 0.50 | 0.50 | 0.50 |
| | Release agent | Type | Behenyl | Behenyl | Behenyl | Behenyl |
| | | | stearate | stearate | stearate | stearate |
| | | Mn | 592 | 592 | 592 | 592 |
| | | Amount | 20 | 20 | 20 | 20 |
| | | (parts) | | | | |
| | Styrene-based | Type | SIS | SIS | SIS | SIS |
| | thermoplastic | Amount | 5.0 | 5.0 | 5.0 | 5.0 |
| | elastomer | (parts) | | | | |
| | MMA for shell | Amount | 3.00 | 3.00 | 3.00 | 3.00 |
| | | (parts) | | | | |

| | | | | | |
|---|---|---|---|---|---|
| | Dv (μm) | 7.7 | 8.0 | 7.7 | 7.7 |
| | Dv/Dn | 1.10 | 1.10 | 1.10 | 1.10 |
| | Average circularity | 0.98 | 0.97 | 0.98 | 0.98 |
| Toner | Bleeding rate | A | A | A | A |
| evaluation | HH durability test | B | A | B | A |
| | Percentage of remaining | 35 | 26 | 35 | 28 |
| | toner (%) in HH durability test | | | | |
| | LL durability test | A | B | A | B |
| | Percentage of remaining | 27 | 35 | 28 | 36 |
| | toner (%) in LL durability test | | | | |
| | HH durability test after | B | A | A | A |
| | storage at high temperature | | | | |
| | Charge fluctuation due to | A | A | A | A |
| | environment | | | | |

TABLE 4

| | | | Example 10 | Example 11 | Example 12 | Example 13 | Example 14 | Example 15 |
|---|---|---|---|---|---|---|---|---|
| Colored | Copolymer A | Type | CCR-A2 | CCR-A3 | CCR-A3 | CCR-A2 | CCR-A1 | CCR-A1 |
| resin | | Functional | 1.50 | 6.00 | 6.00 | 1.50 | 2.00 | 2.00 |
| particles | | group amount | | | | | | |
| | | F_{A} (%) | | | | | | |
| | | Amount m_{A} | 1.50 | 0.70 | 0.70 | 1.50 | 1.50 | 1.50 |
| | | (parts) | | | | | | |
| | Copolymer B | Type | CCR-B4 | CCR-B2 | CCR-B5 | CCR-B2 | CCR-B1 | CCR-B1 |
| | | Functional | 1.20 | 0.10 | 1.40 | 0.10 | 1.00 | 1.00 |
| | | group amount | | | | | | |
| | | F_{B} (%) | | | | | | |
| | | Amount m_{B} | 1.00 | 1.00 | 1.00 | 1.00 | 1.00 | 1.00 |
| | | (parts) | | | | | | |
| | F_{A} − F_{B} | | 0.3 | 5.9 | 4.6 | 1.40 | 1.00 | 1.00 |
| | F_{A} × m_{A} + F_{B} × m_{B} | | 3.45 | 4.30 | 5.60 | 2.35 | 4.00 | 4.00 |
| | Polar resin | Type | P1 | P1 | P1 | P1 | P2 | P3 |
| | | Acid value X | 2.5 | 2.5 | 2.5 | 2.5 | 0.5 | 5.0 |
| | | (mgKOH/g) | | | | | | |
| | | Mw | 12600 | 12600 | 12600 | 12600 | 12500 | 12300 |
| | | Tg (° C.) | 74 | 74 | 74 | 74 | 74 | 74 |
| | | Amount m_{P} | 1.00 | 1.00 | 1.00 | 1.00 | 1.00 | 1.00 |
| | | (parts) | | | | | | |
| | \|X × m_{P} − F_{A} × m_{A}\| | | 0.25 | 1.70 | 1.70 | 0.25 | 2.50 | 2.00 |
| | Release agent | Type | Behenyl | Behenyl | Behenyl | Behenyl | Behenyl | Behenyl |
| | | | stearate | stearate | stearate | stearate | stearate | stearate |
| | | Mn | 592 | 592 | 592 | 592 | 592 | 592 |
| | | Amount | 20 | 20 | 20 | 20 | 20 | 20 |
| | | (parts) | | | | | | |
| | Styrene-based | Type | SIS | SIS | SIS | SIS | SIS | SIS |
| | thermoplastic | Amount | 5.0 | 5.0 | 5.0 | 5.0 | 5.0 | 5.0 |
| | elastomer | (parts) | | | | | | |
| | MMA for shell | Amount | 3.00 | 3.00 | 3.00 | 3.00 | 3.00 | 3.00 |
| | | (parts) | | | | | | |
| | Dv (μm) | | 7.7 | 7.6 | 7.6 | 7.7 | 7.7 | 8.2 |
| | Dv/Dn | | 1.10 | 1.10 | 1.10 | 1.10 | 1.10 | 1.12 |
| | Average circularity | | 0.98 | 0.98 | 0.98 | 0.98 | 0.98 | 0.97 |
| Toner | Bleeding rate | | A | A | A | A | C | A |
| evaluation | HH durability test | | A | A | A | B | A | B |
| | Percentage of remaining | | 28 | 31 | 29 | 35 | 28 | 39 |
| | toner (%) in HH durability test | | | | | | | |
| | LL durability test | | B | C | C | A | C | A |
| | Percentage of remaining | | 35 | 53 | 50 | 28 | 54 | 28 |
| | toner (%) in LL durability test | | | | | | | |
| | HH durability test after | | A | B | B | A | C | A |
| | storage at high temperature | | | | | | | |
| | Charge fluctuation due to | | A | A | A | A | A | C |
| | environment | | | | | | | |
| | | | Example 16 | Example 17 | Example 18 | Example 19 | Example 20 | Example 21 |
| Colored | Copolymer A | Type | CCR-A1 | CCR-A1 | CCR-A1 | CCR-A1 | CCR-A1 | CCR-A1 |
| resin | | Functional | 2.00 | 2.00 | 2.00 | 2.00 | 2.00 | 2.00 |
| particles | | group amount | | | | | | |
| | | F_{A} (%) | | | | | | |
| | | Amount m_{A} | 1.50 | 1.50 | 1.50 | 1.50 | 1.50 | 1.50 |
| | | (parts) | | | | | | |
| | Copolymer B | Type | CCR-B1 | CCR-B1 | CCR-B1 | CCR-B1 | CCR-B1 | CCR-B1 |
| | | Functional | 1.00 | 1.00 | 1.00 | 1.00 | 1.00 | 1.00 |
| | | group amount | | | | | | |
| | | F_{B} (%) | | | | | | |
| | | Amount m_{B} | 1.00 | 1.00 | 1.00 | 1.00 | 1.00 | 1.00 |
| | | (parts) | | | | | | |
| | F_{A} − F_{B} | | 1.00 | 1.00 | 1.00 | 1.00 | 1.00 | 1.00 |
| | F_{A} × m_{A} + F_{B} × m_{B} | | 4.00 | 4.00 | 4.00 | 4.00 | 4.00 | 4.00 |
| | Polar resin | Type | P1 | P1 | P1 | P1 | P1 | P1 |
| | | Acid value X | 2.5 | 2.5 | 2.5 | 2.5 | 2.5 | 2.5 |
| | | (mgKOH/g) | | | | | | |
| | | Mw | 12600 | 12600 | 12600 | 12600 | 12600 | 12600 |
| | | Tg (° C.) | 74 | 74 | 74 | 74 | 74 | 74 |
| | | Amount m_{P} | 1.00 | 1.00 | 1.00 | 1.00 | 1.00 | 1.00 |
| | | (parts) | | | | | | |
| | \|X × m_{P} − F_{A} × m_{A}\| | | 0.50 | 0.50 | 0.50 | 0.50 | 0.50 | 0.50 |
| | Release agent | Type | Ethylene | Behenyl | Behenyl | Behenyl | Behenyl | Sehenyl |
| | | | glycol | behenate | stearate | stearate | stearate | stearate |
| | | | distearate | | | | | |
| | | Mn | 594 | 850 | 592 | 592 | 592 | 592 |
| | | Amount | 20 | 20 | 20 | 20 | 20 | 20 |
| | | (parts) | | | | | | |
| | Styrene-based | Type | SIS | SIS | SBS | SIS | SIS | SIS |
| | thermoplastic | Amount | 5.0 | 5.0 | 5.0 | 5.0 | 2.0 | 10.0 |
| | elastomer | (parts) | | | | | | |
| | MMA for shell | Amount | 3.00 | 3.00 | 3.00 | 0.00 | 3.00 | 3.00 |
| | | (parts) | | | | | | |

| | | | | | | | |
|---|---|---|---|---|---|---|---|
| | Dv (μm) | 7.7 | 7.7 | 7.9 | 7.5 | 7.7 | 7.7 |
| | Dv/Dn | 1.10 | 1.10 | 1.10 | 1.10 | 1.10 | 1.10 |
| | Average circularity | 0.98 | 0.98 | 0.98 | 0.98 | 0.98 | 0.98 |
| Toner | Bleeding rate | A | A | B | A | B | A |
| evaluation | HH durability test | B | A | A | B | A | A |
| | Percentage of remaining | 35 | 27 | 29 | 38 | 28 | 29 |
| | toner (%) in HH durability test | | | | | | |
| | LL durability test | A | B | A | B | A | B |
| | Percentage of remaining | 27 | 34 | 27 | 35 | 29 | 37 |
| | toner (%) in LL durability test | | | | | | |
| | HH durability test after | B | A | B | B | B | A |
| | storage at high temperature | | | | | | |
| | Charge fluctuation due to | A | A | A | A | A | A |
| | environment | | | | | | |

TABLE 5

| | | | Comparative | Comparative | Comparative | Comparative |
|---|---|---|---|---|---|---|
| | | | Example 1 | Example 2 | Example 3 | Example 4 |
| Colored | Copolymer A | Type | CCR-A1 | — | — | CCR-A1 |
| resin | | Functional | 2.00 | — | — | 2.00 |
| particles | | group amount | | | | |
| | | F_{A} (%) | | | | |
| | | Amount m_{A} | 1.50 | — | — | 1.50 |
| | | (parts) | | | | |
| | Copolymer B | Type | — | CCR-B1 | CCR-B1 | CCR-B1 |
| | | Functional | — | 1.00 | 1.00 | 1.00 |
| | | group amount | | | | |
| | | F_{B} (%) | | | | |
| | | Amount m_{B} | — | 1.00 | 2.50 | 1.00 |
| | | (parts) | | | | |
| | Another | Type | — | — | — | — |
| | copolymer C | Functional | — | — | — | — |
| | | group amount | | | | |
| | | F_{C} (%) | | | | |
| | | Amount m_{C} | — | — | — | — |
| | | (parts) | | | | |
| | F_{A} − F_{B} | | — | — | — | 1.00 |
| | F_{A} × m_{A} + F_{B} × m_{B} | | 3.00 | 1.00 | 2.50 | 4.00 |
| | Polar resin | Type | P1 | P1 | P1 | — |
| | | Acid value X | 2.5 | 2.5 | 2.5 | — |
| | | (mgKOH/g) | | | | |
| | | Mw | 12600 | 12600 | 12600 | — |
| | | Tg (° C.) | 74 | 74 | 74 | — |
| | | Amount m_{P} | 1.00 | 1.00 | 1.00 | — |
| | | (parts) | | | | |
| | \|X × m_{P} − F_{A} × m_{A}\| | | 0.50 | 1.50 | 0.00 | — |
| | Release agent | Type | Behenyl | Behenyl | Behenyl | Behenyl |
| | | | stearate | stearate | stearate | stearate |
| | | Mn | 592 | 592 | 592 | 592 |
| | | Amount | 20 | 20 | 20 | 20 |
| | | (parts) | | | | |
| | Styrene-based | Type | SIS | SIS | SIS | SIS |
| | thermoplastic | Amount | 5.0 | 5.0 | 5.0 | 5.0 |
| | elastomer | (parts) | | | | |
| | MMA for shell | Amount | 3.00 | 3.00 | 3.00 | 3.00 |
| | | (parts) | | | | |
| | Dv (μm) | | 7.7 | 7.6 | 7.6 | 7.8 |
| | Dv/Dn | | 1.10 | 1.10 | 1.10 | 1.12 |
| | Average circularity | | 0.98 | 0.98 | 0.98 | 0.97 |
| Toner | Bleeding rate | | D | D | D | D |
| evaluation | HH durability test | | B | D | C | A |
| | Percentage of remaining | | 37 | 62 | 50 | 30 |
| | toner (%) in HH durability test | | | | | |
| | LL durability test | | A | A | A | D |
| | Percentage of remaining | | 29 | 28 | 27 | 70 |
| | toner (%) in LL durability test | | | | | |
| | HH durability test after | | D | D | D | D |
| | storage at high temperature | | | | | |
| | Charge fluctuation due to | | A | A | A | A |
| | environment | | | | | |
| | | | Comparative | Comparative | Comparative | Comparative |
| | | | Example 5 | Example 6 | Example 7 | Example 8 |
| Colored | Copolymer A | Type | CCR-A1 | CCR-A1 | — | CCR-A1 |
| resin | | Functional | 2.00 | 2.00 | — | 2.00 |
| particles | | group amount | | | | |
| | | F_{A} (%) | | | | |
| | | Amount m_{A} | 1.50 | 1.50 | — | 1.50 |
| | | (parts) | | | | |
| | Copolymer B | Type | CCR-B1 | — | CCR-B2 | — |
| | | Functional | 1.00 | — | 0.10 | — |
| | | group amount | | | | |
| | | F_{B} (%) | | | | |
| | | Amount m_{B} | 1.00 | — | 1.00 | — |
| | | (parts) | | | | |
| | Another | Type | — | — | CCR-C1 | CCR-C2 |
| | copolymer C | Functional | — | — | 10.00 | 0.00 |
| | | group amount | | | | |
| | | F_{C} (%) | | | | |
| | | Amount m_{C} | — | — | 0.70 | 1.00 |
| | | (parts) | | | | |
| | F_{A} − F_{B} | | 1.00 | — | 9.90 | 2.00 |
| | F_{A} × m_{A} + F_{B} × m_{B} | | 4.00 | 3.00 | 7.10 | 3.00 |
| | Polar resin | Type | P4 | P1 | P1 | P1 |
| | | Acid value X | 10.0 | 2.5 | 2.5 | 2.5 |
| | | (mgKOH/g) | | | | |
| | | Mw | 12700 | 12600 | 12600 | 12600 |
| | | Tg (° C.) | 74 | 74 | 74 | 74 |
| | | Amount m_{P} | 1.00 | 1.00 | 1.00 | 1.00 |
| | | (parts) | | | | |
| | \|X × m_{P} − F_{A} × m_{A}\| | | 7.00 | 0.50 | 4.50 | 0.50 |
| | Release agent | Type | Behenyl | Ethylene | Behenyl | Behenyl |
| | | | stearate | glycol | stearate | stearate |
| | | | | distearate | | |
| | | Mn | 592 | 594 | 592 | 592 |
| | | Amount | 20 | 20 | 20 | 20 |
| | | (parts) | | | | |
| | Styrene-based | Type | SIS | SIS | SIS | SIS |
| | thermoplastic | Amount | 5.0 | 5.0 | 5.0 | 5.0 |
| | elastomer | (parts) | | | | |
| | MMA for shell | Amount | 3.00 | 3.00 | 3.00 | 3.00 |
| | | (parts) | | | | |

| | | | | | |
|---|---|---|---|---|---|
| | Dv (μm) | 8.1 | 7.7 | 7.5 | 7.7 |
| | Dv/Dn | 1.11 | 1.10 | 1.10 | 1.10 |
| | Average circularity | 0.97 | 0.98 | 0.98 | 0.98 |
| Toner | Bleeding rate | A | D | A | D |
| evaluation | HH durability test | C | B | A | B |
| | Percentage of remaining | 51 | 36 | 28 | 38 |
| | toner (%) in HH durability test | | | | |
| | LL durability test | A | A | D | A |
| | Percentage of remaining | 30 | 29 | 78 | 28 |
| | toner (%) in LL durability test | | | | |
| | HH durability test after | C | D | A | D |
| | storage at high temperature | | | | |
| | Charge fluctuation due to | D | A | A | A |
| | environment | | | | |

Regarding Table 5, in Comparative Examples 2 and 3, |X×m_{P}−F_{B}×m_{B}| was calculated instead of |X×m_{P}−F_{A}×m_{A}|. Also regarding Table 5, in Comparative Example 7, F_{C}−F_{B} was calculated instead of F_{A}−F_{B}; moreover, |X×m_{P}−F_{C}×m_{C}| was calculated instead of |X×m_{P}−F_{A}×m_{A}|.

### [Consideration]

When any one of the copolymers A and B, both of which were used as the positively-chargeable charge control resin, and the polar resin lacked, it was difficult to suppress the bleeding of the release agent while suppressing a print failure.

In Comparative Examples 1 and 6, only the copolymer A was used as the positively-chargeable charge control resin. Accordingly, the bleeding of the release agent was likely to occur when the toner was stored for 30 days in the high-temperature and high-humidity environment at a temperature of 47° C. and a humidity of 80% RH, and fogging was likely to occur in the printing durability test in the high-temperature and high-humidity environment using the toner after storage. It was considered that in Comparative Examples 1 and 6, since only the copolymer A was used as the positively-chargeable charge control resin, and since the amount of the copolymer A was adjusted to allow the toner to obtain an appropriate charge amount, an insufficient amount of the resin was unevenly distributed on the surface of the colored resin particles, and a dense resin layer was not formed.

In Comparative Examples 2 and 3, only the copolymer B was used as the positively-chargeable charge control resin. Accordingly, the bleeding of the release agent was likely to occur when the toner was stored for 30 days in the high-temperature and high-humidity environment at a temperature of 47° C. and a humidity of 80% RH; fogging was likely to occur in the printing durability test in the high-temperature and high-humidity environment using the toner after storage; and fogging was likely to occur also in the printing durability test in the high-temperature and high-humidity environment using the toner before storage. The copolymer B had a relatively small functional group amount. Accordingly, the copolymer B had a small charge imparting effect compared to copolymer A, and it was less likely to be unevenly distributed on the surface side of the colored resin particles. It was considered that in Comparative Examples 2 and 3, since only the copolymer B was used as the positively-chargeable charge control resin, an insufficient amount of the resin was unevenly distributed on the surface of the colored resin particles; a dense resin layer was not formed; and the charge amount of the toner was not able to be sufficiently high.

In Comparative Example 4, the polar resin was not used. Accordingly, the bleeding of the release agent was likely to occur when the toner was stored for 30 days in the high-temperature and high-humidity environment at a temperature of 47° C. and a humidity of 80% RH; fogging was likely to occur in the printing durability test in the high-temperature and high-humidity environment using the toner after storage; and a decrease in image density was likely to occur in the printing durability test in the low-temperature and low-humidity environment using the toner before storage. It was estimated that in Comparative Example 4, since the polar resin was not used, an insufficient amount of the resin was unevenly distributed on the surface of the colored resin particles; a dense resin layer was not formed; and the charge amount of the toner was too high.

In Comparative Example 5, the polar resin having an acid value of more than 8.0 mgKOH/g was used. Accordingly, the change in the charge amount of the toner, which was involved in temperature and humidity changes, was large, and fogging was likely to occur in the printing durability test in the high-temperature and high-humidity environment. It was estimated that in the toner of Comparative Example 5, since the amount of the acidic group contained in the polar resin was large, in the high-temperature and high-humidity environment, charge leakage was likely to be caused by moisture absorption of the acidic group.

In Comparative Example 7, the copolymer having a functional group amount of more than 6.0% by mass was used instead of the copolymer A. Accordingly, a decrease in image density was likely to occur in the printing durability test in the low-temperature and low-humidity environment. It was considered that in Comparative Example 7, since the copolymer having a functional group amount of more than 6.0% by mass was likely to be unevenly distributed on the surface of the colored resin particles, the charge amount of the toner was too high, while a dense resin layer was formed.

In Comparative Example 8, the copolymer containing no functional group was used instead of the copolymer B. Accordingly, the bleeding of the release agent was likely to occur when the toner was stored for 30 days in the high-temperature and high-humidity environment at a temperature of 47° C. and a humidity of 80% RH, and fogging was likely to occur in the printing durability test in the high-temperature and high-humidity environment using the toner after storage. The copolymer containing no functional group did not have a charge imparting effect and was less likely to be unevenly distributed on the surface side of the colored resin particles. Accordingly, it was considered that in Comparative Example 8, since the copolymer having no functional group was used instead of the copolymer B, an insufficient amount of the resin was unevenly distributed on the surface of the colored resin particles, and a dense resin layer was not formed.

In each of the Examples, as the positively-chargeable charge control resin, the copolymer A having a functional group amount of 1.50% by mass or more and 6.00% by mass or less and the copolymer B having a functional group amount of 0.10% by mass or more and less than 1.50% by mass were used; moreover, the polar resin having an acid value of 0.5 mgKOH/g or more and 5.0 mgKOH/g or less was used in combination with them. Accordingly, the bleeding of the release agent was suppressed even when the toner was stored for 30 days in the high-temperature and high-humidity environment at a temperature of 47° C. and a humidity of 80% RH, and the occurrence of fogging was suppressed in the printing durability test in the high-temperature and high-humidity environment using the toner after storage. In the printing durability test using the toner cartridge filled with 500 g of the toner, in both a low-temperature and low-humidity environment and a high-temperature and high-humidity environment, continuous printing was able to be carried out while suppressing a print failure, until the amount of the remaining toner was low. In addition, a change in the charge amount of the toner, which was involved in temperature and humidity changes, was suppressed.

As a result of comparing Examples 1, 16 and 17, it was revealed that the occurrence of fogging in the high-temperature and high-humidity environment was suppressed in Examples 1 and 17, in each of which the monoester was used as the release agent, compared to Example 16 in which the diester was used as the release agent. This was presumed to be because the monoester was more effective in suppressing toner aggregation in the high-temperature and high-humidity environment.

As a result of comparing Examples 1 and 17, it was revealed that a decrease in image density in the low-temperature and low-humidity environment was suppressed in Example 1 in which behenyl stearate was used as the release agent, compared to Example 17 in which behenyl behenate was used as the release agent. This was presumed to be because, since behenyl stearate was more effective in improving the low-temperature fixability of the toner, the toner was likely to be dissolved and spread when fixed, and a decrease in image density was suppressed, accordingly.

As a result of comparing Examples 1 and 18, it was revealed that when the toner was stored in the high-temperature and high-humidity environment, the bleeding of the release agent was suppressed in Example 1 in which the SIS composition was used as the styrene-based thermoplastic elastomer, compared to Example 18 in which the SBS composition was used as the styrene-based thermoplastic elastomer; moreover, the occurrence of fogging in the high-temperature and high-humidity environment using the toner after storage, was suppressed in Example 1 compared to Example 8. This was presumed to be because the dispersibility of the release agent was more improved in the case of using the SIS composition.

As a result of comparing Examples 1 and 19, it was revealed that the occurrence of a print failure in the high-temperature and high-humidity environment and the low-temperature and low-humidity environment, was suppressed in Example 1 in which the core-shell type colored resin particles were used, compared to Example 19 in which the colored resin particles having no shell were used. This was presumed to be because, since the shell suppressed the penetration of the external additive in the printing durability test, a change in the charge amount of the toner, which was due to a deterioration of the toner, was suppressed.

1. A toner comprising colored resin particles, which contain a binder resin, a colorant, a positively-chargeable charge control resin and a release agent, and an external additive,
wherein the positively-chargeable charge control resin comprises a copolymer A, which contains a functional group-containing monomer unit in an amount of 1.50% by mass or more and 6.00% by mass or less, and a copolymer B, which contains a functional group-containing monomer unit in an amount of 0.10% by mass or more and less than 1.50% by mass, and
wherein the colored resin particles further contain a polar resin having an acid value of 0.5 mgKOH/g or more and 8.0 mgKOH/g or less.

2. A toner comprising colored resin particles, which contain a binder resin, a colorant, a positively-chargeable charge control resin and a release agent, and an external additive,
wherein the positively-chargeable charge control resin comprises a copolymer A, which contains a functional group-containing monomer unit in an amount of 1.50% by mass or more and 6.00% by mass or less, and a copolymer B, which contains a functional group-containing monomer unit in an amount of 0.10% by mass or more and less than 1.50% by mass, and
wherein the colored resin particles further contain a polar resin having an acid value of 0.5 mgKOH/g or more and 5.0 mgKOH/g or less.

3. The toner according to claim 1, wherein a sum of products of F and m (F×m) calculated for each of the copolymers contained as the positively-chargeable charge control resin, is 2.00 or more and 6.00 or less when, in each of the copolymers, an amount (% by mass) of the functional group-containing monomer unit is represented as F, and a content (parts by mass) of the copolymer with respect to 100 parts by mass of the binder resin is represented as m.

4. The toner according to claim 1, wherein an absolute value (|X×m_{P}−F_{A}×m_{A}|) of a difference between a product of X and mₚ (X×m_{P}) and a product of F_{A} and m_{A} (F_{A}×m_{A}) is 2.50 or less, when the acid value (mgKOH/g) of the polar resin is represented as X; a content (parts by mass) of the polar resin with respect to 100 parts by mass of the binder resin is represented as m_{P}: the amount (% by mass) of the functional group-containing monomer unit in the copolymer A is represented as F_{A}; and a content (parts by mass) of the copolymer A with respect to 100 parts by mass of the binder resin is represented as m_{A}.

5. The toner according to claim 1, wherein the release agent comprises a fatty acid ester compound, which has a number average molecular weight (Mn) of 500 or more and less than 2,000, at a content of 5 parts by mass or more and 30 parts by mass or less with respect to 100 parts by mass of the binder resin.

6. The toner according to claim 1, wherein the colored resin particles further comprise a styrene-based thermoplastic elastomer at a content of 1 part by mass or more and 10 parts by mass or less with respect to 100 parts by mass of the binder resin.

7. An image forming method using the toner defined by claim 1.

8. The toner according to claim 2, wherein a sum of products of F and m (F×m) calculated for each of the copolymers contained as the positively-chargeable charge control resin, is 2.00 or more and 6.00 or less when, in each of the copolymers, an amount (% by mass) of the functional group-containing monomer unit is represented as F, and a content (parts by mass) of the copolymer with respect to 100 parts by mass of the binder resin is represented as m.

9. The toner according to claim 2, wherein an absolute value (|X×m_{P}−F_{A}×m_{A}|) of a difference between a product of X and mₚ (X×m_{P}) and a product of F_{A} and m_{A} (F_{A}−m_{A}) is 2.50 or less, when the acid value (mgKOH/g) of the polar resin is represented as X; a content (parts by mass) of the polar resin with respect to 100 parts by mass of the binder resin is represented as m_{P}; the amount (% by mass) of the functional group-containing monomer unit in the copolymer A is represented as F_{A}; and a content (parts by mass) of the copolymer A with respect to 100 parts by mass of the binder resin is represented as m_{A}.

10. The toner according to claim 2, wherein the release agent comprises a fatty acid ester compound, which has a number average molecular weight (Mn) of 500 or more and less than 2,000, at a content of 5 parts by mass or more and 30 parts by mass or less with respect to 100 parts by mass of the binder resin.

11. The toner according to claim 2, wherein the colored resin particles further comprise a styrene-based thermoplastic elastomer at a content of 1 part by mass or more and 10 parts by mass or less with respect to 100 parts by mass of the binder resin.

12. An image forming method using the toner defined by claim 2.
